(19) United States
(12) Patent Application Publication
(10) Pub. No.: US 2024/0098338 A1
(43) Pub. Date: Mar. 21, 2024

(54) ATTRIBUTE-BASED CONTENT RECOMMENDATIONS INCLUDING MOVIE RECOMMENDATIONS BASED ON METADATA

(71) Applicant: Rovi Guides, Inc., San Jose, CA (US)

(72) Inventors: Vikram Makam Gupta, Bangalore (IN); Vishwas Sharadanagar Panchaksharaiah, Tumkur District (IN); Reda Harb, Issaquah, WA (US)

(21) Appl. No.: 17/948,655

(22) Filed: Sep. 20, 2022

(51) Int. Cl. H04N 21/466; H04N 21/431; H04N 21/45; H04N 21/482

(52) U.S. Cl. CPC H04N 21/4668; H04N 21/4312; H04N 21/4532; H04N 21/4826

(57) ABSTRACT

Improved content recommendations are generated based on a knowledge graph of a content item, which is based on an attribute of the content item, metadata regarding the content item, a viewing history, and user preferences determined by analysis and selected by a user. An option for selecting attributes of interest from a plurality of attributes is generated for display. A content recommendation based on the selected attributes is generated and displayed in a user interface, which changes as user preference selections change. As a result, a user quickly identifies and consumes a customized list of content items related to the user's favorite actor, character, title, depicted object, depicted setting, actual setting, type of action, type of interaction, genre, release date, release decade, director, MPAA rating, critical rating, plot origin point, plot end point, and the like. Related apparatuses, devices, techniques, and articles are also described.

### BACKGROUND

The present disclosure relates to content delivery and content consumption and, more particularly, to methods and systems for improving provider and consumer control of content items, channels, accounts, subscriptions, metadata, related information, and the like, and generating content recommendations based on the same.

### SUMMARY

Content items, such as a movie or a television show, have several attributes. Conventional approaches provide relatively simplistic recommendations based on these attributes. For example, a given movie is listed in a media guidance application. When the movie is part of a series, some conventional approaches provide recommendations for the movie and other movies in the series.

Conventional recommendation systems are based on collaborative filtering and content-based recommendations. Conventional systems recommend content items to users based on what other people with similar tastes liked, and the user's personal viewing history and preferences for specific genres, sub-genres, casts, and the like. Additionally, some conventional recommendation systems take other factors into account including the time of day, device type, location, language, and the like. These conventional approaches are known as context-aware recommendation systems.

Conventional approaches include providing recommendations by knowledge graphs; providing recommendations using natural language processing (NLP) to find similar movies based on plot summaries (e.g., by using tokenization, stemming, term frequency-inverse document frequency (TF-IDF) (e.g., TfidfVectorizer), unsupervised ML algorithms (e.g., K-means), supervised ML algorithms, similarity distance, and the like); and predicting quality and popularity of a movie from a plot summary and a character description using contextualized work embeddings. See Lee, Jung-Hoon, You-Jin Kim, and Yun-Gyung Cheong, “Predicting Quality and Popularity of a Movie From Plot Summary and Character Description Using Contextualized Word Embeddings,” 2020 IEEE Conference on Games (CoG), IEEE, 2020. Lee proposes the creation of deep learning-based classification models to predict movie success using only the movie scripts and synopses. Lee collected plot summaries and synopses from the IMDB site, which contains movies that have already been released. According to IMDB, whereas the plot summary describes a movie within 250 words avoiding spoilers, a synopsis is a more detailed description of a movie, possibly containing some spoilers. Lee also hypothesized that the character description would enhance the performance of the model for predicting movie quality and popularity and extracted sentences mentioning the main characters of the movie from the synopses.

20th Century Fox uses machine learning (ML) to predict a future movie audience by analyzing trailers. See Campo-Rembado, Miguel, and Sona Oakley, “How 20th Century Fox uses ML to predict a movie audience,” Google Cloud Blog, 2018. See Hsieh, Cheng-Kang, et al., “Convolutional Collaborative Filter Network for Video Based Recommendation Systems,” arXiv preprint arXiv:1810.08189 (2018). The 20th Century Fox approach was driven by the studio's need to understand the audience segment before investing in a script.

Knowledge acquisition systems representing movies and books as well as actors, genres, and the complex interrelationships among them are also described. See Zhu, Yangyong, and Yun Xiong, “Towards Data Science,” Data Science Journal 14 (2015).

An example of a knowledge graph 700 is shown in FIG. 7. The exemplary knowledge graph 700 includes 11 nodes 705-755 as follows: an actor's name 705 (e.g., Tom Hanks), a first movie title 710 (e.g., Catch Me If You Can), a first subgenre name 715 (e.g., Biographical film), a first genre name 720 (e.g., Biography), a first book title 725 (e.g., I Am Malala (Book)), a second genre name 730 (e.g., Non-fiction), an award name 735 (e.g., British Book Awards), a second movie title 740 (e.g., Cloud Atlas), a second subgenre name 745 (e.g., Science Fiction), a second genre name 750 (e.g., Fiction), and a second book title 755 (e.g., Cloud Atlas (Book)). The nodes 705-755 are connected with 14 relationship indicators 760-790b as follows: a starring relationship indicator 760 (e.g., Stars), a co-starring relationship indicator 765 (e.g., Co-stars), a genre relationship indicator 770a-770e (e.g., Has genre) (five instances), a subclass relationship indicator 775a-775c (e.g., Subclass of) (three instances), a derivation/adaptation relationship indicator 780 (e.g., Based on), a class relationship indicator 785 (e.g., Opposite of), and an award relationship indicator 790a and 790b (e.g., Awarded) (two instances). In the exemplary graph 700, each of the nodes has a graphical element (e.g., a circle) and a text label inside the graphical element, and each of the indicators has a graphical element (e.g., an arrow) connecting two nodes and a text label overlaid on the graphical element.

An example of a feature extractor is the MediaPipe YouTube-8M feature extractor, released in 2019, which extracts both visual features (e.g., faces, color, illumination, objects, landscapes, and the like) and audio features. See “YouTube-8M: A Large and Diverse Labeled Video Dataset for Video Understanding Research,” Google, released 2019, accessed Apr. 12, 2022. See Abu-El-Haij a, Sami, et al., “Youtube-8m: A Large-Scale Video Classification Benchmark,” arXiv preprint arXiv:1609.08675 (2016).

A “cold start” makes it challenging for a recommendation system to recommend content to new subscribers since there is no viewing history data available for such subscribers. In a current approach, some over-the-top (OTT) services ask a subscriber during the sign-up phase to indicate their preferences for content genres (e.g., comedy, action, thriller, and the like) and/or for specific content items (e.g., “Do you like Friends?,” “Do you like Avatar?,” and the like). Asking for indications is done so that the recommendation system then recommend content similar to the specific genres or content items (e.g., Friends, Avatar, and the like). The current approach to solving the cold start problem is relatively basic and relies strictly on generic metadata (examples above).

Improvements are needed to overcome these and other problems and limitations of the conventional approaches.

A method for providing content recommendations from among a plurality of content items is provided. The method includes accessing a knowledge graph of a content item. The knowledge graph is based on at least one of an attribute of the content item, metadata regarding the content item, a viewing history, a user preference determined by analysis, or a user preference selected by a user. The method includes selecting one or more attributes of interest from a plurality of attributes of the content item. The method includes generating a content recommendation based on the selected one or more attributes of interest. It is to be understood that the features

The user preference determined by analysis is determined based on an analysis of at least one of the attributes of the content item, the metadata of the content item, the viewing history, or the user preference selected by the user.

The content recommendation only includes portions of one or more original content items that include the selected one or more attributes of interest.

The content recommendation only includes one or more content items that include the selected one or more attributes of interest.

The method further includes determining a prediction of likely interest in one or more content items based on the analysis of the one or more of the attributes of the content item, the metadata of the content item, and a user preference selected by the user.

The attribute is at least one of a title, a genre, a release date, a release decade, an MPAA rating, a critical rating, a season number, an episode number, a director, an actor, a character, a depicted object, a depicted setting, an actual setting, a type of action, a type of interaction, a plot origin point, or a plot end point.

The method further includes generating for display a user interface with one or more options to search one or more content items based on the selected one or more attributes of interest.

The method further includes generating for display a user interface, wherein the user interface changes in response to selections of one or more values and/or weights of the one or more attributes of interest.

The method further includes generating for display a user interface, wherein the user interface is configured to display a timeline referencing the one or more content items.

The timeline is a series of occurrences in the one or more content items that form a plot or part of the plot of the one or more content items.

The attribute includes the timeline or a combination of one or more attributes and the timeline.

The one or more attributes are mapped along the timeline.

The content item is at least one of an image, a video, a text, audio, audiovisual content, electronic media, audio-only content, video-only content, 2D content, 3D content, virtual reality content, composite content, user-generated content, a movie, a program, a segment, a conference, streaming content, an advertisement, live content, a performance, a broadcast, pre-recorded content, computer-generated content, or animated content.

The method further includes generating for display a user interface, wherein the user interface is configured to display each of the one or more content items as a graphical object including within the graphical object one or more symbols corresponding to the one or more attributes.

The attribute in common between two or more content items is displayed with a same symbol for the attribute in common.

The method further includes generating for display a user interface, wherein the user interface is configured to display a relationship indicator representing a relationship between two or more content items sharing at least one attribute in common.

The method further includes generating for display a user interface, wherein the user interface is configured to display a plurality of content items. The content items may include one or more content items of lesser relative interest that do not have the selected one or more attributes of interest and one or more content items of greater relative interest that have the selected one or more attributes of interest. The one or more content items of greater relative interest are highlighted or depicted with a different graphical effect compared to the one or more content items of lesser relative interest.

The method further includes generating for display a user interface, wherein the user interface is configured to display one or more symbols representing the one or more attributes of the one or more content items.

The method further includes generating for display a user interface, wherein the user interface is configured to display one or more graphical representations of a number of the one or more content items that include the one or more attributes.

The method further includes generating for display a user interface, wherein the user interface is configured to display one or more graphical representations of a ratio of the one or more content items that include the one or more attributes versus a total number of the one or more content items displayed in the user interface.

The method further includes generating for display a user interface, wherein the user interface is configured to display a converging plotline in which two or more attributes that were separate at a prior point in a timeline converge.

The method further includes generating for display a user interface, wherein the user interface is configured to display a relationship between one or more convergences of one or more attributes.

The content recommendation is generated with fuzzy logic based on user selection of preferences for a plurality of attributes.

The method further includes generating for display a user interface, wherein the user interface is configured to prompt input of a level of interest in one or more attributes.

The content recommendation is provided in response to a selection of interest in one or more attributes greater than a predetermined threshold.

The content recommendation is provided in response to a determined relevance between one or more content items and one or more attributes.

The content recommendation is based on a combination of a determination of a user interest in one or more content items and a determination of a relevance of the one or more content items to one or more attributes.

The method further includes generating for display a user interface. The user interface is configured so that virtual movement of an on-screen selectable indicator of user interest in at least one attribute of a content item in a first direction consistent with greater interest generally results in a greater number of content items displayed in the user interface. Virtual movement of the on-screen selectable indicator of the user interest in the least one attribute of the content item in a second direction is consistent with lesser interest generally results in a lesser number of content items displayed in the user interface.

The first direction and the second direction include rotation of a virtual dial or sliding of a virtual slidebar in opposite directions.

The method further includes generating for display a user interface, wherein the user interface is configured to present a default set of recommendations based on a predicted interest in one or more content items.

The default set of recommendations is based on a prediction of interest in one or more attributes including at least one of a title, a genre, a release date, a release decade, an MPAA rating, a critical rating, a season number, an episode number, a director, an actor, a character, a depicted object, a depicted setting, an actual setting, a type of action, a type of interaction, a plot origin point, or a plot end point.

The method further includes generating for display a user interface, wherein the user interface is configured to display one or more graphical representations of a ratio of the one or more content items that include the one or more attributes versus a total number of the one or more content items displayed in the user interface. The one or more attributes include at least one of a title, a genre, a release date, a release decade, an MPAA rating, a critical rating, a season number, an episode number, a director, an actor, a character, a depicted object, a depicted setting, an actual setting, a type of action, a type of interaction, a plot origin point, or a plot end point.

The interest in one or more attributes is determined based on a presentation of one or more content trailers associated with the one or more content items.

The one or more content trailers are presented during a sign-up phase.

An interest in one or more attributes is determined based on a rating of the one or more content trailers associated with the one or more content items.

The method further includes generating the knowledge graph based on feedback given about one or more content trailers.

The content recommendation is based at least in part on the knowledge graph for a plurality of subscribers.

The content recommendation is based on at least one of determining one or more content items with similar attributes when compared to a content item receiving a favorable reaction by a user, determining that a user has watched an entirety or a substantial portion of a content item or a series of content items related to each other, determining that a user has re-watched one or more content items, or determining that a user has binge-watched a series of content items.

The content recommendation is based on one or more knowledge graphs of one or more content items.

The one or more knowledge graphs are represented or modeled with objects as vertices, with each object having a unique identifier, with each object having a key-value pair, and with each object connected to other objects via edges describing a relationship between the objects.

Each object is a content item including at least one of a title, a genre, a release date, a release decade, an MPAA rating, a critical rating, a season number, an episode number, a director, an actor, a character, a depicted object, a depicted setting, an actual setting, a type of action, a type of interaction, a plot origin point, or a plot end point.

The relationship between the objects includes at least one of a prequel-sequel pairing, a series relationship, a season relationship, an episodic relationship, or a related content relationship.

The relationship between objects includes at least one source node and at least one target node.

Each pair of the at least one source node and the at least one target node has one or more edges therebetween.

Each edge has one or more properties.

The knowledge graph is based on at least one of an analysis of closed caption data, a video analysis using machine vision, or a deep neural network model.

The closed caption data includes an analysis of sentences.

Analysis of at least one of the closed caption data, the machine vision, or the deep neural network model extracts one or more features from one or more video frames.

Analysis of at least one of the closed caption data, the machine vision, or the deep neural network model creates tags and/or vectors for one or more frames for the one or more content items.

The closed caption data includes a textual representation of at least one of audio, a non-speech element, a character identification, a sound effect, a language identification, an expressed emotion, a music lyric, or timing metadata.

The method further comprises updating an existing knowledge graph to include output from the analysis of at least one of the closed caption data, the machine vision, or the deep neural network model to creates tags and/or vectors for one or more frames for the one or more content items.

The method further comprises weighting one or more events in the one or more content items with one or more attributes determined by the analysis of at least one of the closed caption data, the machine vision, or the deep neural network model.

The weighting is determined based on a video phase and/or an analysis phase of a computer vision system.

The method further comprises determining a relationship strength between two or more content items.

The relationship strength is based on one or more labels determined from the analysis of at least one of the closed caption data, the machine vision, or the deep neural network model.

The relationship strength is based on an extent of an overlap between the one or more labels determined from the analysis of at least one of the closed caption data, the machine vision, or the deep neural network model.

The relationship strength is based on an analysis of a timing of events within the one or more content items.

A search for content is based on a search of the knowledge graph.

The one or more trailers are presented based on the search of the knowledge graph.

The one or more trailers are presented based on metadata including demographics of an audience associated with certain content.

The one or more trailers are presented in a sign-up phase based on trailers of new releases relatively highly favored by a particular gender classification within a particular age range.

The a list of one or more additional trailers is determined based on user ratings of presented trailers.

The method further comprises analysis based on one or more of collaborative filtering; content-based recommendations; context-aware recommendation systems; prediction of quality and/or popularity of a content item from metadata (e.g., a plot summary or a character description, using contextual information embedded into the metadata); and a feature extractor.

The content recommendation is based on at least one of a determination of preferences of a group of users determined to have similarity with a given user, the viewing history, a user preference, a genre, a sub-genre, an actor, a cast, a time of day, a device type, a location, a language, the knowledge graph, natural language processing, a plot summary, tokenization, stemming, TF-IDF, K-means, similarity distance, deep learning-based classification models, ML analysis, or knowledge acquisition.

The customized metadata is generated for each user and for each of the one or more content items.

The customized metadata replaces generic metadata provided for a given content item.

A system is provided. The system includes control circuitry configured to perform one or more of any of the functions noted herein.

A non-transitory, computer-readable medium having non-transitory, computer-readable instructions encoded thereon is provided. The instructions, when executed by control circuitry, cause the control circuitry to perform one or more of any of the functions noted herein.

A device is provided, which includes one or more means to perform one or more of any of the functions noted herein.

Any of the features of the methods and systems above are obtained with a trained model. The model is trained with one or more knowledge graphs. The one or more knowledge graphs are determined by a trained model.

Notably, the present disclosure is not limited to the combination of the elements as listed herein and may be assembled in any combination of the elements as described herein. These and other capabilities of the disclosed subject matter will be more fully understood after a review of the following figures, detailed description, and claims.

### BRIEF DESCRIPTIONS OF THE DRAWINGS

The present disclosure, in accordance with one or more various embodiments, is described in detail with reference to the following figures. The drawings are provided for purposes of illustration only and merely depict embodiments. These drawings are provided to facilitate an understanding of the concepts disclosed herein and should not be considered limiting of the breadth, scope, or applicability of these concepts. It should be noted that for clarity and ease of illustration these drawings are not necessarily made to scale.

The embodiments herein are better understood by referring to the following description in conjunction with the accompanying drawings, in which like reference numerals indicate identically or functionally similar elements, and in which:

FIG. 1A depicts a user watching Game of Thrones on a display device and making a voice request for specific content relating to a character via a voice-enabled remote control device according to an exemplary embodiment;

FIG. 1B depicts a response to the voice request of FIG. 1A including display of currently playing content in a picture-in-picture portion of the display, display of a graphical user interface (GUI) relating to the voice request, and a clarifying audio response relating to the same according to an exemplary embodiment;

FIG. 1C depicts the user watching another scene from Game of Thrones on the display device and making a voice request for specific content relating to a type of action via the voice-enabled remote control device according to an exemplary embodiment;

FIG. 1D depicts a response to the voice request of FIG. 1C including display of currently playing content in the picture-in-picture portion of the display, display of a GUI relating to the voice request, and a clarifying audio response relating to the same according to an exemplary embodiment;

FIG. 1E depicts the user watching yet another scene from Game of Thrones on the display device and making a “catch-up” voice request for specific content relating to another character via the voice-enabled remote control device according to an exemplary embodiment;

FIG. 1F depicts a response to the voice request of FIG. 1E including display of currently playing content in the picture-in-picture portion of the display, display of a GUI relating to the voice request, a responsive/confirmatory audio response relating to the same, and display of an earlier scene relating to the responsive/confirmatory audio response according to an exemplary embodiment;

FIG. 1G depicts the user watching still another scene from Game of Thrones on the display device and making a voice request for specific content relating to a pair of characters via the voice-enabled remote control device according to an exemplary embodiment;

FIG. 1H depicts a response to the voice request of FIG. 1G including display of currently playing content in the picture-in-picture portion of the display, display of a GUI relating to the voice request, a responsive/confirmatory audio response relating to the same, and display of an earlier scene relating to the responsive/confirmatory audio response according to an exemplary embodiment;

FIG. 1I depicts a representation of a content item according to an exemplary embodiment;

FIG. 2 depicts a two-tiered GUI including “fan-in” content items related to a content item according to an exemplary embodiment;

FIG. 3 depicts a three-tiered GUI according to an exemplary embodiment;

FIG. 4 depicts a five-tiered GUI with user-selectable virtual slidebars in a first state according to an exemplary embodiment;

FIG. 5 depicts the five-tiered GUI after the user-selectable virtual slidebars are moved to a second state according to an exemplary embodiment;

FIG. 6 depicts another five-tiered GUI with user-selectable virtual slidebars and additional information relating to content items according to an exemplary embodiment;

FIG. 7 depicts a knowledge graph relating movies, actors, genres, subclasses, related books, and related awards;

FIG. 8 depicts a flowchart of a method for providing content recommendations from among a plurality of content items according to an exemplary embodiment;

FIG. 9 depicts attributes of content items according to an exemplary embodiment;

FIG. 10 depicts a flowchart of processes relating to display of a GUI according to an exemplary embodiment;

FIG. 11 depicts a flowchart of additional processes relating to the display of the GUI according to an exemplary embodiment;

FIG. 12 depicts additional processes relating to the display of the GUI according to an exemplary embodiment;

FIG. 13 depicts processes relating to determination of interest, generation of a knowledge graph, and content recommendations according to an exemplary embodiment;

FIG. 14 depicts additional processes relating to content recommendations and the knowledge graph according to an exemplary embodiment;

FIG. 15 depicts additional processes relating to the knowledge graph, weightings, and determinations of relationship strength according to an exemplary embodiment;

FIG. 16 depicts additional processes relating to uses of the knowledge graph, trailers, metadata, types of analysis, and content recommendations according to an exemplary embodiment;

FIG. 17 depicts types of content items according to an exemplary embodiment;

FIG. 18 depicts an artificial intelligence system according to an exemplary embodiment; and

FIG. 19 depicts a system including a server, a communication network, and a computing device for performing the methods and processes according to an exemplary embodiment.

The drawings are intended to depict only typical aspects of the subject matter disclosed herein, and therefore should not be considered as limiting the scope of the disclosure. Those skilled in the art will understand that the structures, systems, devices, and methods specifically described herein and illustrated in the accompanying drawings are non-limiting embodiments.

### DETAILED DESCRIPTION

Improved methods and systems provide improved content recommendations. The methods and systems create an improved graph of a content item (e.g., a movie). The graph is based on attributes, user preferences (determined and/or selected by the user), and/or metadata. Also, user preferences may also be determined based on an analysis of content, user ratings, metadata, and the like. The methods and systems overcome problems with conventional approaches. For example, a viewer may be most interested in a particular attribute (e.g., a favorite actor, a favorite genre, a particular type of action and/or scene, and the like). In some situations, the viewer is only interested in the particular attribute. The viewer may not need to know and/or may not be interested in other attributes. The viewer also may or may not be interested in viewing an entirety of a content item to enjoy the particular attribute. The methods and systems provide a viewer with a recommendation including content having at least one particular attribute the viewer finds interesting, content having only one particular attribute the viewer finds interesting, versions of content items edited and/or shortened to only include one particular attribute the viewer finds interesting, and the like.

The techniques and approaches disclosed herein address and overcome the problems of prior approaches. Notably, the present disclosure is not limited to the combination of the elements as listed herein and is assembled in any combination of the elements as described herein. These and other capabilities of the disclosed subject matter will be more fully understood after a review of the following figures, detailed description, and claims. Singular references (e.g., an image) are understood to refer to and include plural references (e.g., a plurality of images) and vice versa.

Methods and systems are described for recommending content based on attributes of interest to a user. For example, if a user is interested in a certain attribute, then movies that do not include the user's preferred attribute are not recommended. The methods and systems provide the user with one or more options to search for content (e.g., movies), and the search is easily changed and viewed by prompting the user to change one or more values and/or weights of one or more attributes (e.g., via a GUI).

An “attribute” as used herein includes at least one of an actor (e.g., Mark Hamill), character (e.g., Luke Skywalker), title (e.g., Star Wars: Episode IV— A New Hope (movie)), depicted object (e.g., a lightsaber), depicted setting (e.g., Tatooine), actual setting (e.g., Tunisia), type of action (e.g., fight), type of interaction (e.g., Luke Skywalker kisses Leia Organa), genre (e.g., science fiction), release date (e.g., 1977), release decade (e.g., 1970s), director (e.g., George Lucas), MPAA rating (e.g., PG), critical rating (e.g., 8.6 stars), plot origin point (e.g., Anakin's first appearance in Star Wars: Episode I—The Phantom Menace), or plot end point (e.g., Anakin's death in Star Wars: Episode VI—Return of the Jedi), and the like. A “timeline” as used herein is a connected series of occurrences that form a plot or part of the plot of a story, drama, event, performance, or the like. The attribute may also be a timeline with any combination of multiple attributes. An attribute may also be a timeline and a combination of attributes mapped along the timeline.

As used herein, “content item” (or “content”) includes but is not limited to an image, video, text, audio, audiovisual content, electronic media, audio-only content, video-only content, 2D content, 3D content, virtual reality content, composite content, a plurality of videos, user generated content, movies, programs, segments, conferences, streaming content, advertisements, live content (including, e.g., performances and broadcasts), pre-recorded content, computer-generated content, animated content, and the like. The content is provided in any suitable format. The content is stored on any storage device or system configured for content storage.

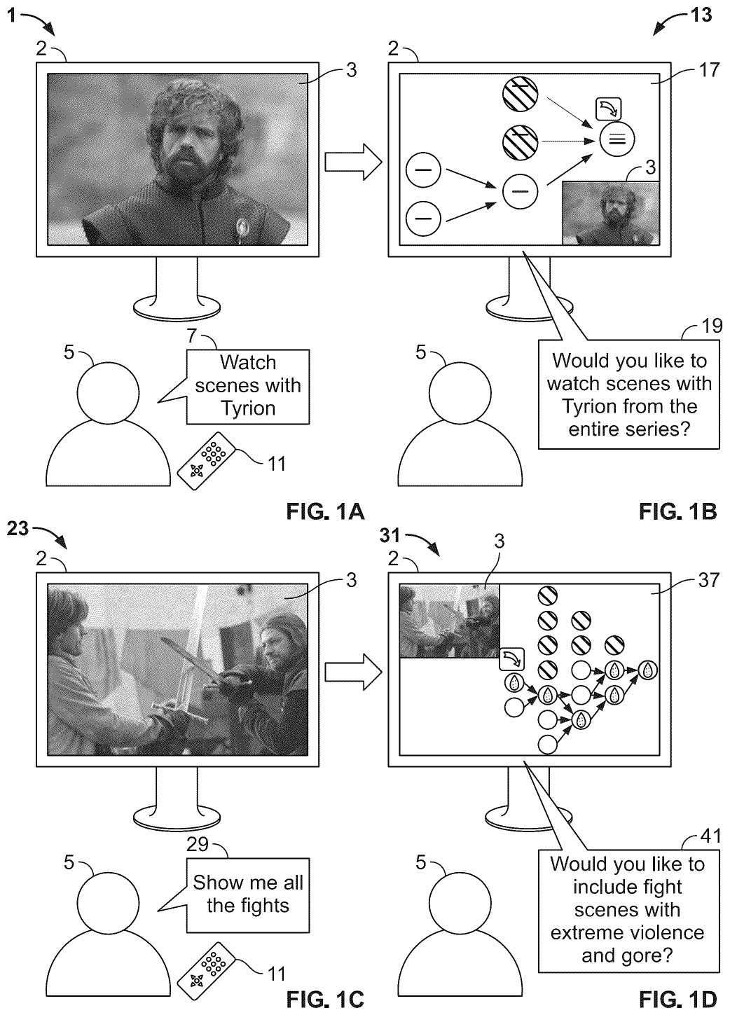

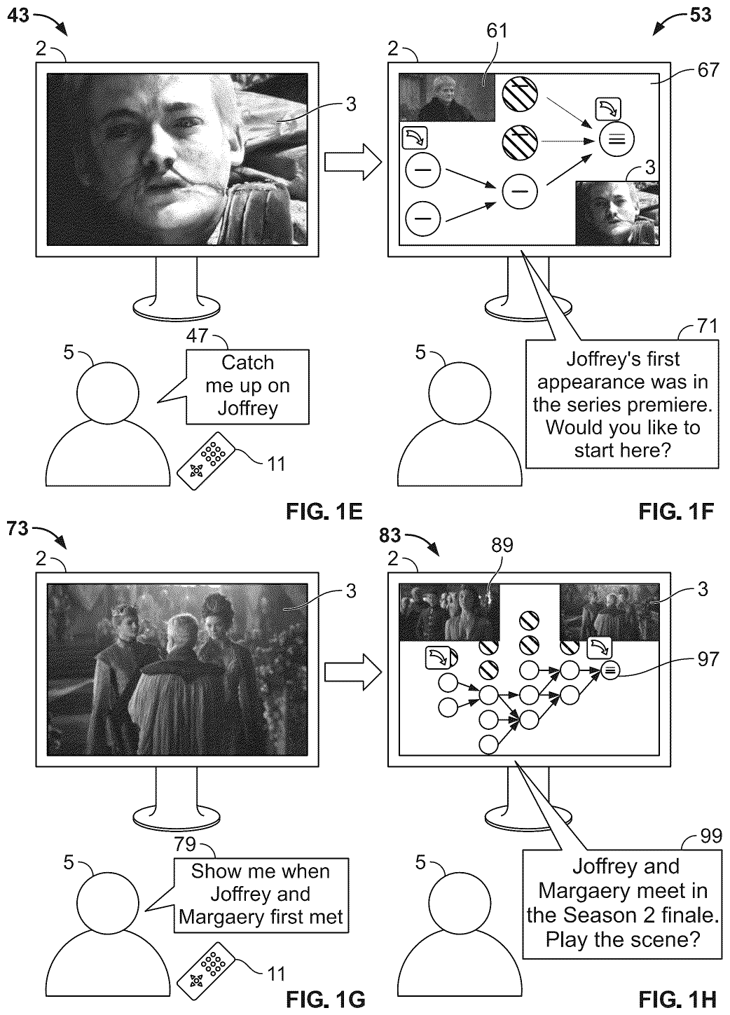

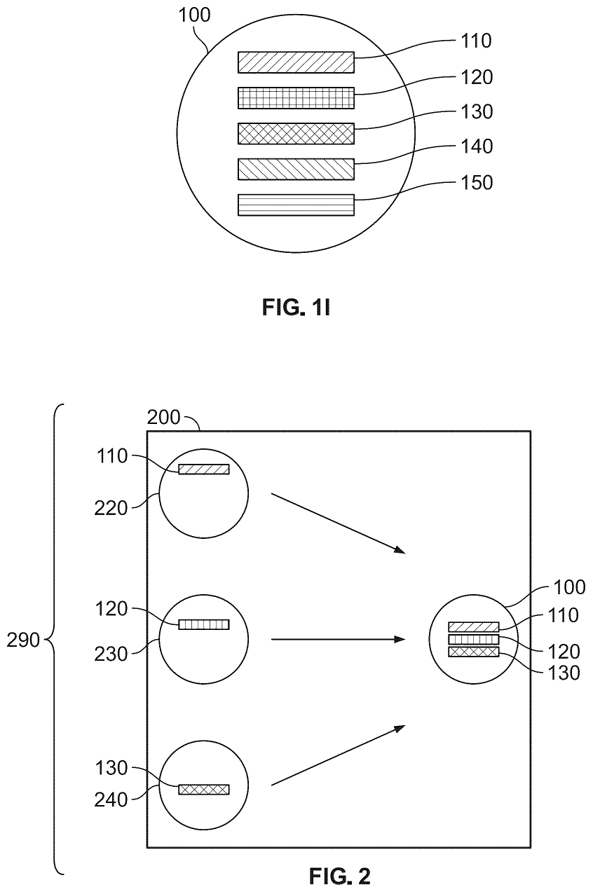

FIG. 1A depicts a first part 1 of a first use case scenario with a user 5 watching currently playing content 3 (e.g., a scene from Game of Thrones with Tyrion Lannister played by Peter Dinklage) on a display device 2 and making a voice request 7 (e.g., “Watch scenes with Tyrion”) for specific content relating to a character (e.g., Tyrion Lannister) via a voice-enabled remote control device 11 according to an exemplary embodiment. The request need not necessarily be a voice request received by a voice-enabled remote. Other types of requests are used, such as on-screen character entry, on-screen autocomplete systems, on-screen menus, and the like. Disambiguation and natural language processing techniques are employed to parse the request into a format suitable for computerized processing and analysis. The request is received by a remote control, a computer or input device connected with or integrated into the display device 2 or any other suitable input device.

FIG. 1B depicts a second part 2 of the first use case scenario in which the methods and systems receive and process the voice request 7, provide a response to the voice request 7 including display of the currently playing content 3 in a picture-in-picture portion of the display device 2, display a GUI 17 relating to the voice request 7, and output a clarifying audio response 19 (e.g., “Would you like to watch scenes with Tyrion from the entire series?”) relating to the voice request 7 according to an exemplary embodiment. Details regarding the generation of the GUI 17 are described in greater detail with reference to FIGS. 1I-7 below. Since Tyrion is a central character in Game of Thrones, the request, “Watch scenes with Tyrion,” yields numerous results. In an initial state, the GUI 17 presents the user 5 with all the possible scenes from the entire Game of Thrones series. The methods and systems analyze user preferences, the user's viewing history, and metadata (e.g., about other viewers of Game of Thrones with demographics similar to those of the present user), and the methods and systems determine that the user is frequently interested in consuming about 120 minutes of content in a single viewing session. In response, the methods and systems respond to the voice request 7 with the clarifying audio response 19 before proceeding to play all scenes featuring Tyrion. The GUI 17 is not limited to that shown in FIG. 1B and may include fewer or more features and less or more functionalities. For instance, The GUI 17 includes indicators representing each scene including Tyrion (circles linked with arrows in this example), another type of indicator highlighting which of these scenes is currently playing (a curved arrow in this example), and other useful information. Each indicator is selectable and configured to retrieve and display the scene corresponding with the selected indicator and/or other information regarding the scene. Although the clarifying audio response 19 is shown as audio output, the information is conveyed to the user 5 via text displayed on the display device 2 or any other suitable means. The format and/or grammatical structure of the response 19 is provided to match and/or emulate the format and/or grammatical structure of the request 7 using suitable techniques. For instance, in this example, the terms “watch,” “scenes” and “Tyrion” are reflected in the response 19. Also, the types of requests are not limited to a currently playing series. For instance, in response to a request such as “Find movies with the actor who plays Tyrion,” the methods and systems are configured to disambiguate the inquiry, determine the user's intent to identify movies including the actor playing Tyrion (i.e., Peter Dinklage), search a movie database for movies including Peter Dinklage, sort the results by popularity or based on some other desirable sorting parameter, and display options for selecting and/or purchasing content items responsive to the request. Further, the currently playing content 3 portion is user selectable such that, upon selection, the display reverts to normal playback such as that shown in FIG. 1A. Although the currently playing content 3 is shown, it need not necessarily be displayed in the manner shown or at all. For instance, the GUI 17 is superimposed over the currently playing content 3 as an opaque or semi-transparent overlay element, as a combination of opaque and semi-transparent elements, as a split screen, on a separate display device, or any other suitable display technique.

In response to an affirmative response by the user 5 to the response 19, the methods and systems are configured to begin playback of a series of responsive content items. For instance, the methods and systems are configured to deliver a first scene from a plurality of scenes including the character Tyrion.

The methods and systems are configured to display or communicate additional information and/or additional clarifying question(s) relating to the inquiry, for example, “Tyrion appears in 67 episodes of Game of Thrones and in more than 100 scenes,” “Would you like to store a new playlist including these results?,” “Would you like to watch all the scenes in order?,” “Would you like recommendations for selected portions of these scenes?,” and the like. In response to an affirmative response by the user 5 to the additional clarifying question, the methods and systems are configured to offer selectable options such as “Watch popular scenes including Tyrion,” “Watch important scenes including Tyrion,” and the like. Popularity and importance are based on viewing data from a large group of viewers, analysis of social media, human-curated databases, computer-aided and human-curated databases, plot summaries, critical analyses, and other suitable metrics and sources. The types of responses are based on analysis of user preferences, user profiles, metadata, and other suitable sources of information.

In response to a negative response by the user 5 to the response 19, the methods and systems are configured to revert to normal playback such as that shown in FIG. 1A and/or to prompt additional clarifying questions, such as “Would you like to watch scenes with Tyrion from the currently playing season of Game of Thrones?” and the like.

FIG. 1C depicts a first part 23 of a second use case scenario with the user 5 watching currently playing content 3 (e.g., another scene from Game of Thrones, i.e., a sword duel between Jaime Lannister (played by Nikolaj Coster-Waldau) and Ned Stark (played by Sean Bean), from Game of Thrones) on the display device 2 and making a voice request 29 (e.g., “Show me all the fights”) for specific content relating to a type of action via the voice-enabled remote control device 11 according to an exemplary embodiment.

FIG. 1D depicts a second part 31 of the second use case scenario in which the methods and systems receive and process the voice request 29, provide a response to the voice request 29 including display of the currently playing content 3 in the picture-in-picture portion of the display device 2, display a GUI 37 relating to the voice request 29, and output a clarifying audio response 41 (e.g., “Would you like to include fight scenes with extreme violence and gore?”) relating to the voice request 29 according to an exemplary embodiment. The methods and systems are configured to analyze information such as user profiles to determine, for example, that a user has a particular affinity for violent content, and thus display a message such as “Would you like to include fight scenes with extreme violence and gore?” Conversely, the methods and systems are configured to analyze such information to determine, for example, that a household of the user includes children under the age of 18, and that the content items corresponding to a response to the voice request 29 contain content having an NC-17 MPAA rating (no one 17 or under admitted). Thus the methods and systems display a message such as “Would you like to exclude fight scenes with extreme violence and gore?” and, if affirmed by the user, remove scenes tagged with such content from the list to be displayed. Such editing is performed without user interaction, for instance, by reviewing user settings and profiles, analyzing viewing history, analyzing metadata, and the like. The content items depicted in the GUI 37 are further displayed with symbols representing violent content (e.g., a symbol representing a drop of blood as illustrated here).

FIG. 1E depicts a first part 43 of a third use case scenario with the user 5 watching currently playing content 3 (e.g., yet another scene from Game of Thrones, i.e., the death of Joffrey Baratheon played by Jack Gleeson) on the display device 2 and making a “catch-up” voice request 47 (e.g., “Catch me up on Joffrey”) for specific content relating to another character via the voice-enabled remote control device 11 according to an exemplary embodiment. For instance, when the user 5 has not watched earlier seasons of Game of Thrones, upon seeing the death of Joffrey, the user 5 becomes interested in catching up on plotlines involving Joffrey. The methods and systems are configured to effectively receive, process, and deliver content responsive to such “catch-up” inquiries. The methods and systems are configured to give particular significance to phrases such as “catch up,” “catch me up,” “I want to learn more about,” “show me everything about” and the like, and attach to such phrases a user's interest in consuming some or all portions of content relating to the subject (or an attribute of a content item) named in the request. That is, the methods and systems are configured, in response to a request including phrases such as those noted above, to perform the functions described in detail herein that enable “catch-up” functionality.

FIG. 1F depicts a second part 53 of the third use case scenario in which the methods and systems receive and process the “catch-up” voice request 47, provide a response to the voice request 47 including display of the currently playing content 3 in the picture-in-picture portion of the display device 2, display a GUI 67 relating to the “catch-up” voice request 47, output a responsive/confirmatory audio response 71 (e.g., “Joffrey's first appearance was in the series premiere. Would you like to start here?”) relating to the “catch-up” voice request 47, and display an earlier scene 61 (e.g., Joffrey's first appearance in Winterfell during the series premiere) relating to the responsive/confirmatory audio response 71 according to an exemplary embodiment. Joffrey's first appearance (in earlier scene 61) and Joffrey's death (in the currently playing content 3 of the present example) represent, for Joffrey's character, an exemplary plot origin point and plot end point, respectively, described in greater detail below.

FIG. 1G depicts a first part 73 of a fourth use case scenario with the user 5 watching currently playing content 3 (e.g., still another scene from Game of Thrones, i.e., the marriage of Joffrey Baratheon and Margaery Tyrell (played by Natalie Dormer)) on the display device 2 and making a voice request 79 (e.g., “Show me when Joffrey and Margaery first met”) for specific content relating to a pair of characters via the voice-enabled remote control device 11 according to an exemplary embodiment.

FIG. 1H depicts a second part 83 of the fourth use case scenario in which the methods and systems receive and process the voice request 79, provide a response to the voice request 79 including display of the currently playing content 3 in the picture-in-picture portion of the display device 2, display a GUI 97 relating to the voice request 79, output a responsive/confirmatory audio response 99 (e.g., “Joffrey and Margaery meet in the Season 2 finale. Play the scene?”) relating to the voice request 79, and display an earlier scene 89 (e.g., Margaery meeting Joffrey after the death of Renly Baratheon (played by Gethin Anthony)) relating to the responsive/confirmatory audio response 99 according to an exemplary embodiment. FIGS. 1G and 1H represent an example of a converging plotline (e.g., the convergence (i.e., marriage) of the characters Joffrey and Margaery, which signifies a union of the Baratheon and Tyrell Houses (notwithstanding Joffrey's true parentage), etc.) discussed in greater detail below.

The next section discusses processing that enables the functionality exemplified in the use case scenarios explicitly described herein and all functionality disclosed herein.

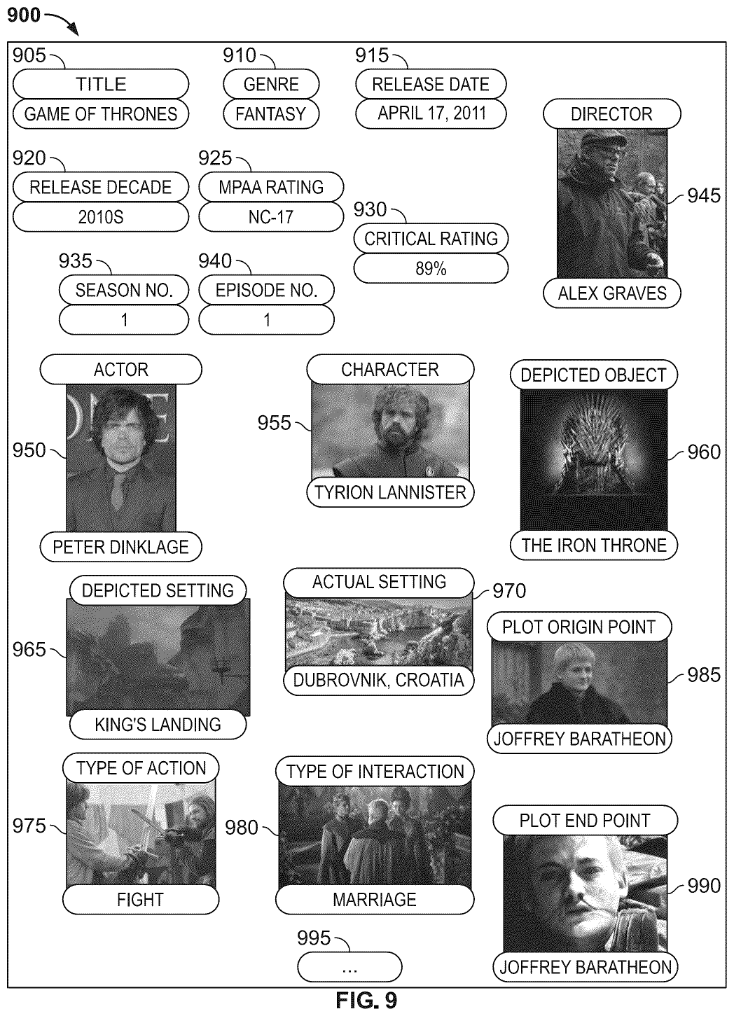

FIG. 1I depicts a representation of a content item (e.g., a movie) with different attributes. For example, first movie 100 includes five attributes including first attribute 110, second attribute 120, third attribute 130, fourth attribute 140, and fifth attribute 150 (exemplary attributes are provided in FIG. 9 and related descriptions). Each of the attributes 110-150 is displayed with a different symbol. Throughout the disclosure, various visual elements are illustrated and described. These elements are exemplary. Other suitable symbols, iconography and/or visual elements are understood to be included.

FIG. 2 depicts “fan-in” content items related to a content item by at least one common attribute. For example, fan-in movies 290 include second movie 220, third movie 230, and fourth movie 240. Each of the movies 220, 230, 240 is related to the first movie 100 and vice versa. The relationship between the fan-in movies 290 and the first movie 100 is depicted with an arrow, as shown. The fan-in movies 290 are a set of movies preceding the first movie 100. The fan-in movies 290 are also referred to as “catch-up” movies. The second movie 220 includes the first attribute 110, which is in common with the first movie 100. The third movie 230 includes the second attribute 120, which is in common with the first movie 100. The fourth movie 240 includes the third attribute 130, which is in common with the first movie 100. None of the fan-in movies 290 includes the fourth attribute 140 or the fifth attribute 150.

The methods and systems recommend the first movie 100 and the fourth movie 240 to a viewer interested in the third attribute 130. The second movie 220 and the third movie 230, which do not have the third attribute 130, are not necessarily recommended, and/or are excluded from a display of recommendations.

The methods and systems determine a recursive set of fan-in movies for every movie in a catalog. In other words, each movie is fed by precedent movies. Each movie in a set of preceding movies has its own attributes and precedent movies.

The methods and systems use filtering logic to recommend movies having associated attributes of interest to the viewer.

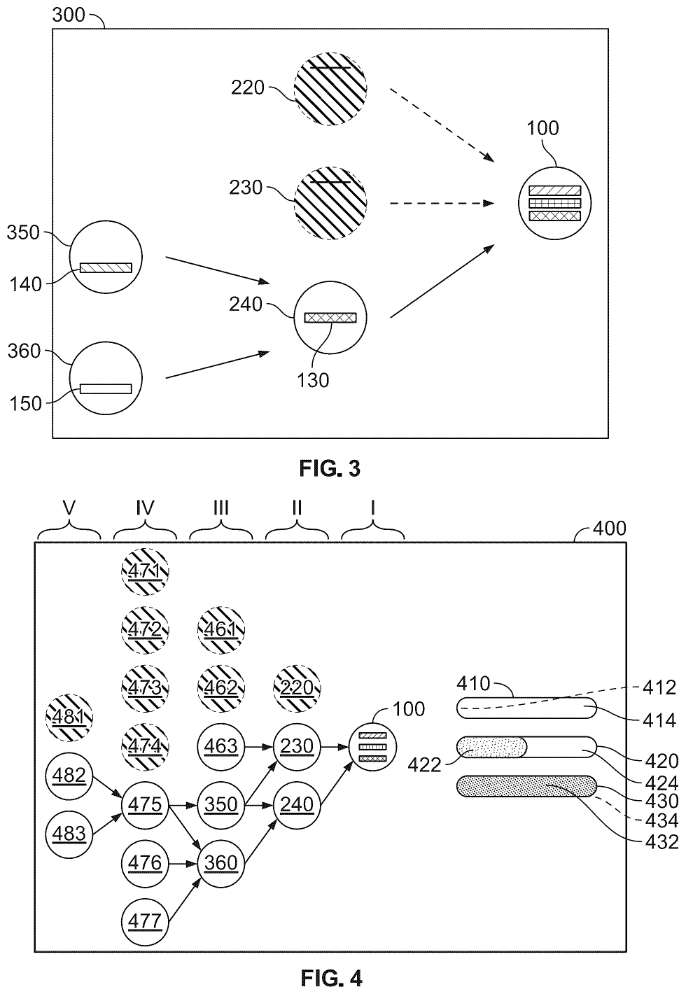

The methods and systems generate a movie graph 200 for display. The movie graph 200 is part of a GUI. The movie graph 200 displays the first movie 100 adjacent a right edge of a display area, and the fan-in movies 200 adjacent a left edge of the display area. Other suitable arrangements and visual elements are provided. Each movie in the fan-in set has its own fan-in movies (see, e.g., FIG. 3). The movie graph 200 includes multiple layers of movies.

In some embodiments, each movie has a unique set of attributes. The methods and systems are configured to recommend a set of movies for the viewer to watch after filtering out all movies that include and/or do not include certain attributes.

In various layers of any given movie graph, several attributes converge to a subsequent attribute. For example, as shown in FIG. 3, a fifth movie 350 has the fourth attribute 140, and a sixth movie 360 has the fifth attribute 150. The filtering logic adds to a recommendation one or more movies having attributes that converge in later movies. In this example, the methods and systems provide, in response to a viewer interest in the third attribute 130, a recommendation for the fourth movie 240 as well as the fifth movie 350 having the fourth attribute 140 and the sixth movie 360 having the fifth attribute 150, which converge to the third attribute 130. The convergence of the fourth attribute 140 and the fifth attribute 150 could, for example, initially occur in the fourth movie 240. The methods and systems include relationships between such convergences.

For example, a first character is represented by the fourth attribute 140 of the fifth movie 350, and a second character is represented by the fifth attribute 150 in the sixth movie 360. Then, the first and second characters get married in the fourth movie 240, and the fourth and fifth attributes 140, 150 converge into the third attribute 130. Referring to the use case scenarios, for example, scenes with Joffrey are coded with one attribute code (e.g., 140 in the example of FIG. 3), scenes with Margaery are coded with another attribute code (e.g., 150), and scenes with both characters are coded with a combined attribute code (e.g., 130). A divorce of the first and second characters or death of one of the characters (e.g., the death of Joffrey) triggers a divergence of attributes in a subsequent scene, segment, episode and/or movie (e.g., a movie symbolically displayed to the right side of a GUI 300 as shown on FIG. 3 is considered subsequent to those displayed to the left of it). In FIG. 3, the fourth attribute 140 and the fifth attribute 150 converge to the third attribute 130.

The methods and systems provide a recommendation for a set of movies containing entire movies, i.e., a relatively long catch-up, and/or certain scenes having certain attributes of the movies, i.e., a relatively shorter catch-up.

The methods and systems utilize fuzzy logic, a form of many-valued logic in which, The truth value of variables may be any real number between 0 and 1. The methods and systems provide the viewer an option to fuzzily select how interested they are in one or more attributes. For example, the viewer inputs 100% interest in the third attribute 130, and 50% interest in the second attribute 120. The methods and systems apply, The fuzzy parameters into the filtering logic. Referring to the example of FIG. 2, the methods and systems necessarily include the fourth movie 240, since the viewer has indicated a 100% interest in the third attribute 130, even when the fourth movie 240 has a relatively small relevance to the third attribute 130. Whereas, since the viewer has indicated a 50% interest in the second attribute 120, the methods and systems recommend a movie with a relatively strong relevance to the second attribute 120. The methods and systems recommend one or more movies in response to the viewer indicating an interest greater than (or greater than or equal to) a predetermined threshold, e.g., greater than or equal to 50%. The methods and systems recommend one or more movies in response to a determined relevance between a given movie and a given attribute satisfying a condition, e.g., if a relevance of an attribute is determined to be greater than or equal to 50% relevant to a movie, then the attribute is considered relevant to the movie. Recommendations are based on a combination of interest and relevance. Boolean logic is employed. For example, a recommendation for a movie is made when a relevance of greater than or equal to 50% is determined between an attribute and a movie, AND when an interest of the viewer in the attribute is greater than or equal to 50%. Also, for example, a recommendation for a movie is made when a relevance of greater than or equal to 50% is determined between an attribute and a movie, OR when an interest of the viewer in the attribute is greater than or equal to 50%. It is understood that although a relatively simplistic 0% to 100% scale is described, other scales and systems are employed in some embodiments including binary systems (e.g., thumbs up, thumbs down), alphanumeric systems (e.g., A, B, C, D, F), a number of symbols (e.g., 1-5 stars), complex multi-variable systems, and the like.

A GUI is configured to display symbols representing a plurality of content items. The GUI includes a plurality of user-selectable options for indicating an interest in a given attribute. The user-selectable options are configured to allow a viewer to move symbols or provide input to indicate interest in an attribute.

For example, in FIG. 4, a GUI 400 depicts a plurality of movies as a plurality of circles, respectively (in this case, 19 movies are depicted with 19 circles). As described above, each circle representing each movie includes different colored and/or patterned lines indicating different attributes of each movie within each circle. In FIG. 4, only the attributes of the first movie 100 are shown inside the circle representing the movie, but attributes are omitted from the first movie 100 and/or shown in other movies. Also, in this example, five layers of movies (depicted here as columns of circles) with respective fan-in relationships are shown. The first movie 100 is in the right-most column I. The second movie 220, the third movie 230, and the fourth movie 240 are shown in the second-to-the-right-most column II. Movies 461-463, the fifth movie 350, and the sixth movie 360 are shown in the center column III. Movies 471-477 are shown in the second-to-the-left-most column IV. Movies 481-483 are shown in the left-most column V. Movies 481-483 are fan-in movies with respect to movies 471-477. Movies 471-477 are fan-in movies with respect to movies 461-463, 350, 360. Movies 461-463, 350, 360 are fan-in movies with respect to movies 220, 230, 240. Movies 220, 230, 240 are fan-in movies with respect to the movie 100.

The GUI 400 includes one or more user selectable options for indicating an interest level in one or more attributes. In FIG. 4, for example, a first user-selectable slide bar 410 indicates an interest in the first attribute 110, a second user selectable slide bar 420 indicates an interest in the second attribute 120, and a third user selectable slide bar 430 indicates an interest in third attribute 130. Each user-selectable slide bar includes a first indicator and a second indicator for indicating a level of interest relative to a scale. In FIG. 4, for example, the first user-selectable slide bar 410 is in a default setting, has not been selected or has been moved into a position indicating a minimum interest (e.g., 0%) in the first attribute 110. As such, in this example, 0% of a first indicator 412 (e.g., no solid fill) in the first attribute 110 is displayed on the first user selectable slide bar 410, and 100% of a second indicator 414 (e.g., all lighter fill) in the first attribute 110 is displayed on the first user-selectable slide bar 410. The second and third user-selectable slide bars 420, 430 are set at about 45% and 100% interest, respectively. Specifically, the second user-selectable slide bar 420 is in a default setting, has been selected or has been moved into a position indicating partial interest (e.g., about 45%) in the second attribute 120. As such, in this example, about 45% of a second indicator 422 (e.g., about 45% solid fill) in the second attribute 120 is displayed on the second user-selectable slide bar 420, and about 55% of a second indicator 424 (e.g., about 55% lighter fill) in the second attribute 120 is displayed on the second user-selectable slide bar 420. Similarly, the third user-selectable slide bar 430 is in a default setting, has been selected or has been moved into a position indicating maximum interest (e.g., about 100%) in the third attribute 130. As such, in this example, about 100% of a third indicator 432 (e.g., all solid fill) in the third attribute 130 is displayed on the third user-selectable slide bar 430, and about 0% of a third indicator 434 (e.g., no lighter fill) in the third attribute 130 is displayed on the third user-selectable slide bar 430. In some embodiments, an indication of interest in a content item (e.g., 45% interest) implies a corresponding disinterest in the content item (e.g., 55% disinterest, where a scale of the interest is, e.g., 0%-100%).

FIG. 4 depicts the GUI 400 upon selection of about 0% interest in the first attribute 110 using the first user-selectable slide bar 410, about 45% interest in the second attribute 120 using the second user-selectable slide bar 420, and about 100% interest in the third attribute 130 using the third user selectable slide bar 430. As a result, a first group of movies 100, 230, 240, 463, 350, 360, 475-477, 482, and 483, i.e., 11 of the 19 movies are highlighted (or marked with any other suitable indicia) to indicate a relationship and/or a sufficiently significant relationship between the movie and the selected attributes at the selected interest level. A second group of movies 220, 461, 462, 471-474, and 481, i.e., eight of the 19 movies, are not highlighted (or are grayed out, or not displayed at all) to indicate the lack of a relationship and/or the lack of a significant relationship between the movie and the selected attributes at the selected interest level. That is, for example, each of the first group of movies 100, 230, 240, 463, 350, 360, 475-477, 482, and 483 has relatively little or no content determined to be related to the first attribute 110; at least some content determined to be related to the second attribute 120; and relatively high amounts of content determined to be related to the third attribute 130. Conversely, each of the second group of movies 220, 461, 462, 471-474, and 481 has relatively high amounts of content determined to be related to the first attribute 110; at least some content determined to be related to the second attribute 120; and relatively low amounts of content determined to be related to the third attribute 130. In general, in the example of FIG. 4, the higher the three user-selectable slide bars are set, generally fewer movies will be determined to be matches, and the lower the three user-selectable slide bars are set, generally more movies will be determined to be matches.

As described above with reference to FIG. 2, the GUI 400 of FIG. 4 also illustrates the fan-in relationships between movies. Based on the selected settings, the viewer is provided with a recommendation indicating that some, all and/or portions of the first group of movies 230, 240, 463, 350, 360, 475-477, 482, and 483 could be watched as catch-up portions and/or movies before watching the first movie 100.

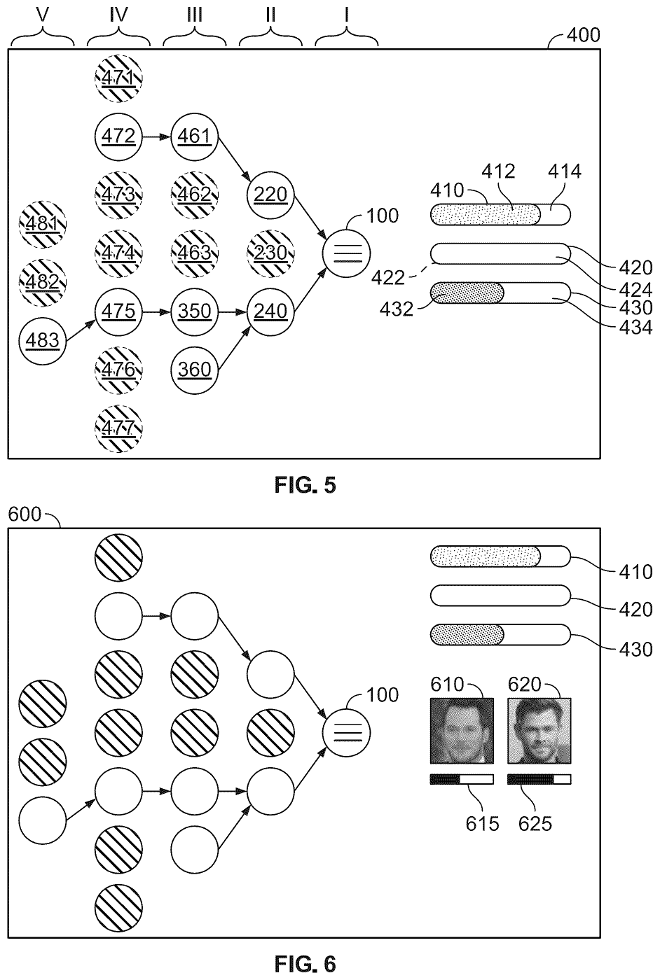

In some embodiments, FIG. 4 displays the GUI 400 based on a default interest of the viewer in at least one of the first attribute 110, the second attribute 120, or the third attribute 130. The default interest is based on an analysis of at least one of a user profile, viewing history, previously inputted user preferences, or user ratings of movies, and the like. The viewer is presented with the default set of recommendations represented by the GUI 400 of FIG. 4, and the viewer subsequently adjusts the interest levels to generate a new set of recommendations as depicted, for example, in FIG. 5.

FIG. 5 is similar to FIG. 4 except that the viewer utilized the first user-selectable slide bar 410 to indicate significantly higher interest, e.g., about 75% interest, in the first attribute 110 relative to the interest demonstrated in FIG. 4. The viewer indicates this relatively higher interest by clicking or touching a screen on a point in the bar 410 (which may display a grab point indicia (not shown)), holding the click to grab the bar 410, sliding the grabbed bar 410 to the desired level of interest, and releasing the grab of the bar 410 by letting go of the click (or any other suitable input approach), and/or by clicking directly on a point in the bar 410 corresponding with the desired level of interest. Other inputs include entry of a numeric value representing the interest of the viewer, use of a remote control with directional navigation and selection buttons, a voice command stating the level of interest, and the like.

The first indicator 412 is correspondingly generated with about 75% solid fill and the second indicator 414 with about 25% relatively lighter fill. Also, relative to FIG. 4, in FIG. 5, the viewer utilized the second user-selectable slide bar 420 to indicate significantly less interest, e.g., about 0% interest, in the second attribute 120 relative to the interest demonstrated in FIG. 4. The first indicator 422 is correspondingly generated with about 0% solid fill and the second indicator 424 with about 100% relatively lighter fill. Further, relative to FIG. 4, in FIG. 5, the viewer utilized the third user-selectable slide bar 430 to indicate lesser interest, e.g., about 45% interest, in the third attribute 130 relative to the interest demonstrated in FIG. 4. The first indicator 432 is correspondingly generated with about 45% solid fill and the second indicator 434 with about 55% relatively lighter fill.

As a result of the new selections, the methods and system generate a new recommendation including a set of movies matching the selections. Specifically, as shown, for example, in FIG. 5, a third group of movies 100, 220, 240, 461, 350, 360, 472, 475, and 483, i.e., nine of the 19 movies are highlighted (or marked with any other suitable indicia) to indicate a relationship and/or a sufficiently significant relationship between the movie and the selected attributes at the selected interest level. A fourth group of movies 230, 462, 463, 471, 473, 474, 476, 477, 481, and 482, i.e., 10 of the 19 movies, are not highlighted (or are grayed out, or not displayed at all) to indicate the lack of a relationship and/or the lack of a significant relationship between the movie and the selected attributes at the selected interest level.

The methods and systems generate a GUI 600 with additional parameters of interest that change and update as the viewer selects and/or changes an interest level for various attributes.

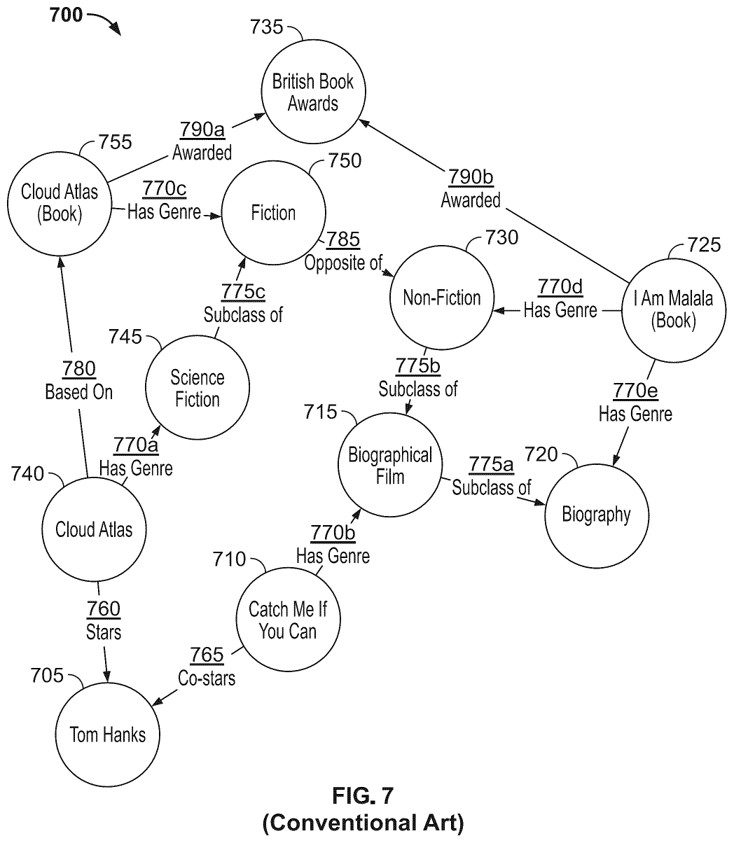

For example, FIG. 6 is similar to FIG. 5, except the bars 410, 420, 430 are closer to a top edge of the display screen of the GUI 600, and additional information is displayed regarding the recommended movies. In FIG. 6, some duplicative references have been removed to depict the exemplary GUI 600 without clutter.

The additional information includes an image of an actor and/or an indicator and/or a graphic representing a frequency of movies in which the displayed actor appears. For example, as shown in FIG. 6, the GUI 600 displays a first image of the actor Chris Pratt 610, a first bar 615 indicating that Chris Pratt appears in three of the highlighted eight fan-in movies (37.5%), a second image of the actor Chris Hemsworth 620, and a second bar 625 indicating that Chris Hemsworth appears in six of the highlighted eight fan-in movies (62.5%). In this example, the viewer's interest in Chris Pratt and Chris Hemsworth need not necessarily be two of the three attributes. The GUI 600 is useful in that it allows a viewer to adjust attributes and provides the user with on-the-fly visual feedback via the first and second bars 615, 625 regarding the impact of the changed attribute on the number of movies including, e.g., a favorite actor or actors.

In another example, the attributes are assigned to actors, where the first attribute 110 corresponds with the viewer's interest in the actor Chris Pratt, and the third attribute 130 corresponds with the viewer's interest in the actor Chris Hemsworth. Recommendations are generated. Both Chris Pratt and Chris Hemsworth appear in the movie Thor: Love & Thunder. In this example, the first movie 100 represents Thor: Love & Thunder, and the first movie 100 is highlighted to indicate the appearance of both actors. In this example, the first bar 615 indicates that four of the highlighted nine movies include Chris Pratt (about 44.4%), and the second bar 625 indicates that Chris Hemsworth appears in seven of the highlighted nine movies (about 77.8%). That is, in this example where the actors are assigned to some of the attributes, the GUI would include relatively larger first and second bars.

Attributes are not limited to any particular category. Attributes include for example, at least one of a title, a genre, a release date, a release decade, an MPAA rating, a critical rating, a season number, an episode number, a director, an actor, a character, a depicted object, a depicted setting, an actual setting, a type of action, a type of interaction, a plot origin point, or a plot end point, and the like.

The embodiments of FIGS. 1A to 6 are combinable in any suitable manner. For instance in response to a user inputting a request, “I'm interested in scenes including Tyrion and Jaime taking place in King's Landing,” the attributes shown in FIGS. 4-6 are appropriately adjusted. That is, in response to the request noted above, the three attributes 110, 120, 130, correspond with the character Tyrion, the character Jaime, and the depicted setting King's Landing; the attributes 110, 120, 130 are set at 100% or any other suitable indicator of interest (greater than 50% in some embodiments); a list of scenes satisfying these conditions is generated in a manner similar to that disclosed above; and a GUI containing selectable options to view one or more portions of the list is presented to the user in response. As a result, the user is provided with an easily navigable, useful tool for finding and consuming content of interest.

Identification and Analysis of Attributes

Additional details are provided below describing examples of how attributes are identified and/or analyzed, and how user preferences are mapped to attributes. The recommendation system collects information from the user regarding attributes that are of interest. The information is collected by presenting movie trailers during a sign-up phase and asking for a rating (e.g., thumbs up or thumbs down) and/or to provide a numeric rating of the trailer associated with the content. New subscribers are open to giving extensive feedback (at least during the sign-up phase) since they know that volunteering such information will help them discover content and get the full value out of their subscription.

Content for trailers is normally selected to appeal to a wide audience with various tastes and content preferences (e.g., comedy, action, drama, suspense, horror, and the like). Therefore, they are suited to infer at least some user preferences. The methods and systems utilize trailers to recommend similar content.

Recommendations are generated by creating a movie events knowledge graph and using such graph to make recommendations to new subscribers (based on feedback they give about the trailers that they watch and rate). Such graph is used to further refine the accuracy of the recommendation system for all subscribers. In some embodiments, recommendations are generated by at least one of analyzing the user's viewing history, finding movies with similar attributes when compared to a movie that a user enjoyed, utilizing the user's explicit feedback (e.g., giving the movie a thumbs-up), utilizing data indicating that the user has watched an entirety or substantial portion of a movie, or utilizing data indicating that the user has re-watched the movie, and the like.

In some embodiments, graph databases are utilized. Entities in such a graph are represented or modeled as vertices (objects) with a unique identifier and properties (key-value pairs) and connected to other objects (which also have a unique identifier and properties) via edges that describe the relationship between the objects. For example, the properties of an object are a movie name, genre, release date, and the like. The type of the relationship (property type of the edge) between two movies is for example, type: Sequel; type: Prequel; type: Series; type: Second Season; and the like. Source and target nodes have multiple edges between them, and these edges have multiple properties.

The knowledge graph is created for many digital content items (e.g., movies) based on closed caption data including analysis of the sentences as well as other data described below, along with video analysis (using machine vision and deep neural network models) to extract features from video frames and create tags or vectors for individual frames, and for a content item.

Closed caption files include additional information beyond just textual representation of the audio within a movie or an episode of a TV series. For example, non-speech elements include character identification, sound effects (crowd cheering, explosion, and the like), language identification (someone says something in Korean or Spanish), expressed emotions (e.g., sobbing, slurring while speaking, and the like), lyrics of music, and the like, are also part of the closed caption data, along with timing metadata.

The methods and systems update existing movie knowledge graphs to add additional edges of type including sounds (e.g., explosions, romantic music, police sirens, and the like). The database includes weights that are associated with the occurrence of such sounds throughout the whole content. These weights are determined during the video/analysis phase by the appropriate computer visions systems being used.

Data regarding relationship strength are based on the labels from the various video/audio/closed caption analysis. For example, two movie trailers are related based on an amount of overlap between their labels (e.g., sounds, visual features, similar actors, and the like). The timing of events within the content impacts, The relationship strength. For example, a movie about bank robbery might include shooting during heists starting from the beginning of the movie—i.e., excessive shooting sounds in, e.g., Public Enemies, while Inside Man does not include as much, and such sounds are heard as the plot progresses.

A user that gives a high rating to a trailer that has explosion sounds could lead the recommendation systems to recommend content (i.e., full movies) associated with a related trailer based on the relationship strength parameter.

In one embodiment, the knowledge graph is used to enable a subscriber to search for content with specific parameters, such as explosions, car sirens, and the like, and to exclude others, e.g., comedy. The search for content with specific parameters is used to generate a list of movies that are strictly action movies and not action-comedies.

In one embodiment, the trailers to be presented first are based on the parameters specified in the previous embodiment. Similarly, metadata about the movie audience is available for content and is associated with demographics. An initial set of trailers is presented based on such data. For example, trailers of new releases that were heavily favored by males between the ages of 23-43 are selected for the new subscriber to rate at the sign-up phase. For example, the list of trailers is sampled to cover different genres and dynamically updated as the user rates the trailers.

The methods and systems include analysis based on at least one of collaborative filtering; content-based recommendations; context-aware recommendation systems; prediction of quality and/or popularity of a movie from metadata (e.g., a plot summary and a character description using contextualized embeddings); or a feature extractor. Recommendations are based on at least one of determination of what other viewers with similar tastes liked, personal viewing history, user preference, genre, sub-genre, actor, cast, time of day, device type, location, language, knowledge graph, NLP, plot summaries, tokenization, stemming, TF-IDF, K-means, similarity distance, deep learning-based classification models, ML analysis, or knowledge acquisition systems. In some embodiments, customized metadata is generated for each viewer for each content item, as opposed to generic metadata provided for a given content item.

### Exemplary Embodiments

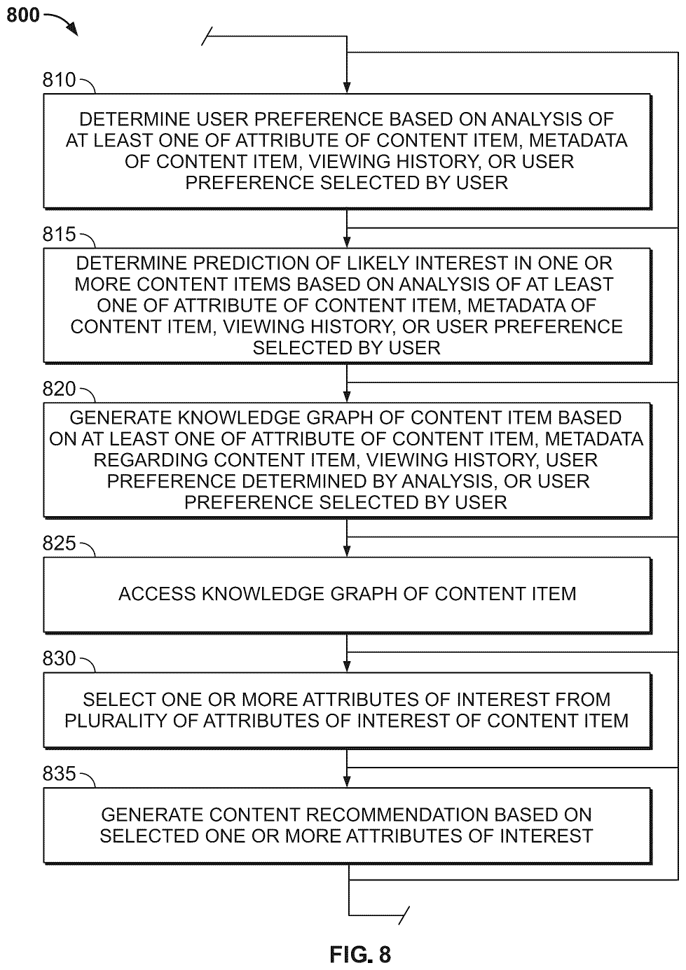

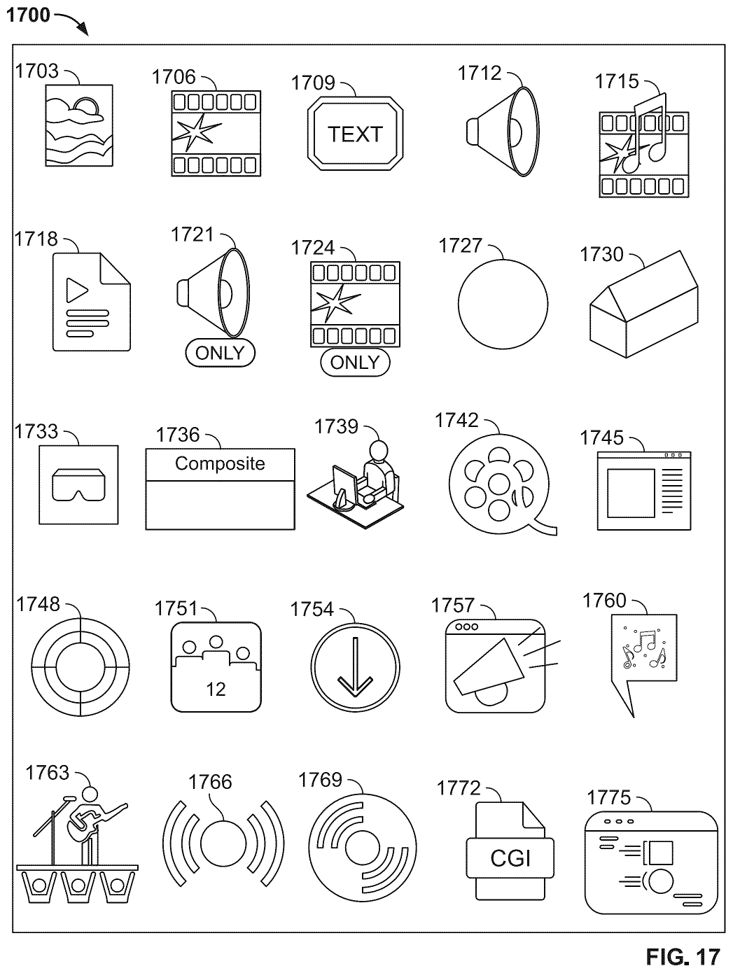

FIG. 8 depicts a flowchart of a method 800 for providing content recommendations (e.g., GUIs 17, 37, 67, 97, 200, 300, 400, 600) from among a plurality of content items 1700 (FIG. 17) according to an exemplary embodiment. The method 800 includes accessing 825 a knowledge graph (e.g., FIG. 7) of a content item 1703-1775, the knowledge graph (e.g., FIG. 7) based on at least one of attributes 110-150, 905-995 of the content item 1703-1775, metadata regarding the content item 1703-1775, a viewing history, a user preference determined 810 by analysis, or a user preference selected by a user 5. The method 800 includes selecting 830 one or more attributes 110-150, 905-955 of interest from a plurality of attributes 110-150, 905-955 of the content item 1703-1775. The method 800 includes generating 835 a content recommendation (e.g., GUIs 17, 37, 67, 97, 200, 300, 400, 600) based on the selected one or more attributes 110-150, 905-955 of interest. The user preference determined 810 by analysis is determined based on an analysis of at least one of the attributes 110-150, 905-995 of the content item 1703-1775, the metadata of the content item 1703-1775, the viewing history, or the user preference selected by the user 5.

The content recommendation (e.g., GUIs 17, 37, 67, 97, 200, 300, 400, 600) only includes portions (e.g., scenes or segments) of one or more original content items 1700 that include the selected one or more attributes 110-150, 905-955 of interest.

The content recommendation (e.g., GUIs 17, 37, 67, 97, 200, 300, 400, 600) only includes one or more content items 1700 that include the selected one or more attributes 110-150, 905-955 of interest.

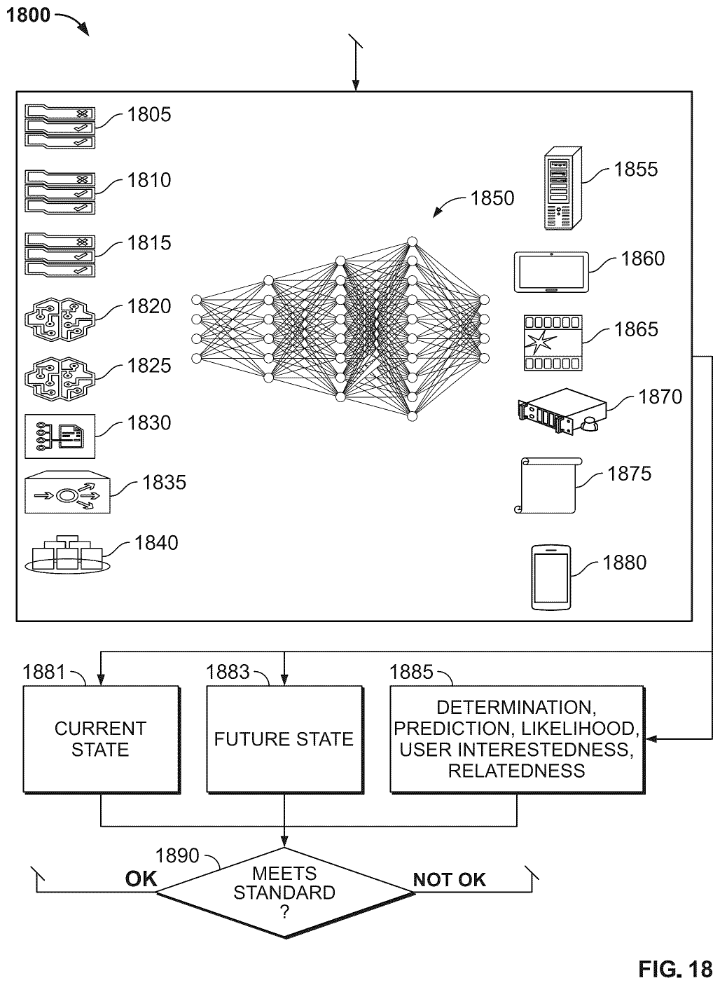

The method 800 includes determining 815 a prediction 1885 (FIG. 18) of likely interest in one or more content items 1700 based on the analysis of the one or more of the attributes 110-150, 905-995 of the content item 1703-1775, the metadata of the content item 1703-1775, and the user preference selected by the user 5.

The process 800 includes one or more of the processes 800, 1000, 1100, 1200, 1300, 1400, 1500, 1600, and 1800 of FIGS. 8, 10-16, and 18, respectively.

FIG. 9 depicts attributes 110-150, 905-955 of content items 1700 according to an exemplary embodiment. The at least one of the attributes 110-150, 905-995 is at least one of a title 905 (e.g., Game of Thrones), a genre 910 (e.g., Fantasy), a release date 915 (e.g., Apr. 17, 2011), a release decade 920 (e.g., 2010s), an MPAA rating 925 (e.g., NC-17), a critical rating 930 (e.g., 89% on Rotten Tomatoes, IMDb, Metacritic, Fandango, CinemaScore, user ratings, a composite of multiple rating systems, or any other type of critical rating), a season number 935 (e.g., 1), an episode number 940 (e.g., 1), a director 945 (e.g., Alex Graves), an actor 950 (e.g., Peter Dinklage), a character 955 (e.g., Tyrion Lannister), a depicted object 960 (e.g., The Iron Throne), a depicted setting 965 (e.g., King's Landing), an actual setting 970 (e.g., Dubrovnik, Croatia), a type of action 975 (e.g., fight), a type of interaction 980 (e.g., marriage), a plot origin point 985 (e.g., first appearance of Joffrey Baratheon), or a plot end point 990 (e.g., death of Joffrey Baratheon). Other attributes 995 are provided including a custom attribute, a user-defined attribute, and the like. The exemplary attributes provided in FIG. 9 are appropriate to an episodic, seasonal series such as HBO's Game of Thrones (2011-2019). Other sets of attributes are provided as appropriate to the type of content.

In FIGS. 8, 10-16, and 18, one, more, or all of the steps of the various processes may be performed in any suitable combination, and in any suitable order with or without any other step or process shown therein. Exceptions include subprocesses (such as 1025, 1030, 1035, each of which requires prior process 1020), which are shown vertically offset from other processes. Otherwise, each of the processes and subprocesses is interchangeable and combinable with others as appropriate. Each of FIGS. 8, 10-16, and 18 includes an open-ended arrow indicating a connection with any other of FIGS. 8, 10-16, and 18.

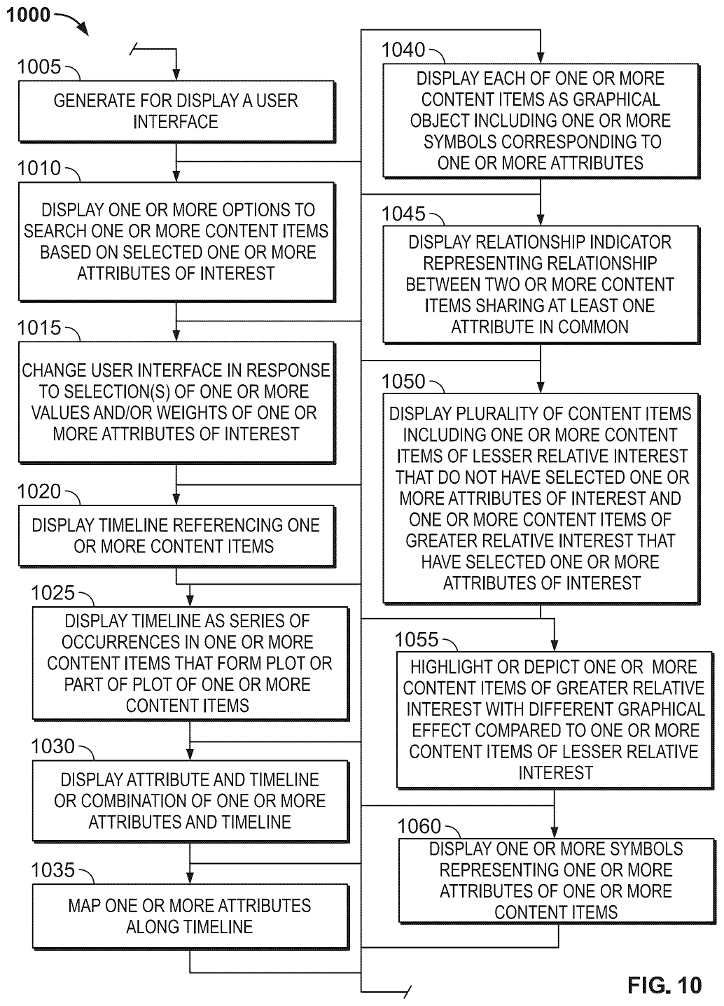

FIG. 10 depicts processes 1000 relating to display of GUIs 17, 37, 67, 97, 200, 300, 400, 600 according to an exemplary embodiment. The method 800 of FIG. 8 includes a process 1000. The process 1000 includes generating 1005 for display at least one of the GUIs 17, 37, 67, 97, 200, 300, 400, or 600 with display 1010 of one or more options to search one or more content items 1700 based on the selected one or more attributes 110-150, 905-955 of interest. The at least one of the GUIs 17, 37, 67, 97, 200, 300, 400, or 600 changes 1015 in response to selections of one or more values and/or weights of the one or more attributes 110-150, 905-955 of interest. The at least one of the GUIs 17, 37, 67, 97, 200, 300, 400, or 600 is configured to display 1020 a timeline referencing the one or more content items 1700. The process 1000 includes displaying 1025 the timeline as a series of occurrences in the one or more content items 1700 that form a plot or part of the plot of the one or more content items 1700. The process 1000 includes displaying 1030 the attribute 110-150, 905-995 and the timeline or a combination of one or more attributes 110-150, 905-955 and the timeline. The process 1000 includes mapping 1035 the one or more attributes 110-150, 905-955 along the timeline.

The at least one of the GUIs 17, 37, 67, 97, 200, 300, 400, or 600 is configured to display 1040 each of the one or more content items 1700 as a graphical object including within the graphical object one or more symbols corresponding to the one or more attributes 110-150, 905-955. An attribute 110-150, 905-995 in common between two or more content items 1700 is displayed with a same symbol.

The at least one of the GUIs 17, 37, 67, 97, 200, 300, 400, or 600 is configured to display 1045 a relationship indicator representing a relationship between two or more content items 1700 sharing at least one attribute 110-150, 905-995 in common. The user interface 17, 37, 67, 97, 300, 400, 600 is configured to display 1050 a plurality of content items 1700 including one or more content items 1700 of lesser relative interest that do not have the selected one or more attributes 110-150, 905-955 of interest and one or more content items 1700 of greater relative interest that have the selected one or more attributes 110-150, 905-955 of interest. The one or more content items 1700 of greater relative interest are highlighted or depicted 1055 with a different graphical effect compared to the one or more content items 1700 of lesser relative interest. The at least one of the GUIs 17, 37, 67, 97, 200, 300, 400, or 600 is configured to display 1060 one or more symbols representing the one or more attributes 110-150, 905-955 of the one or more content items 1700.

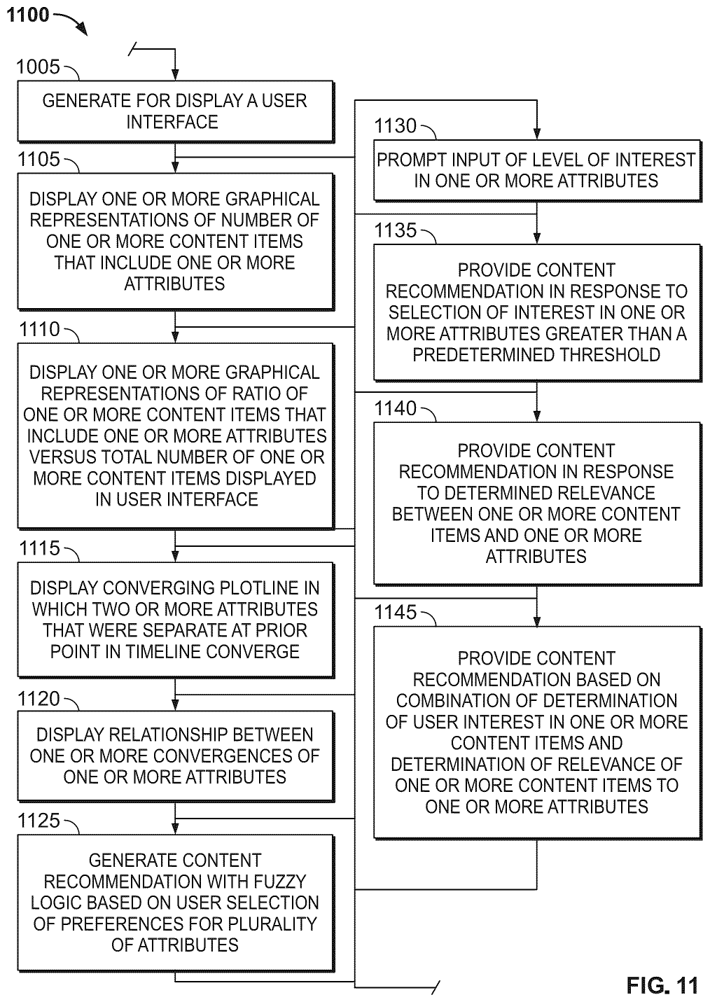

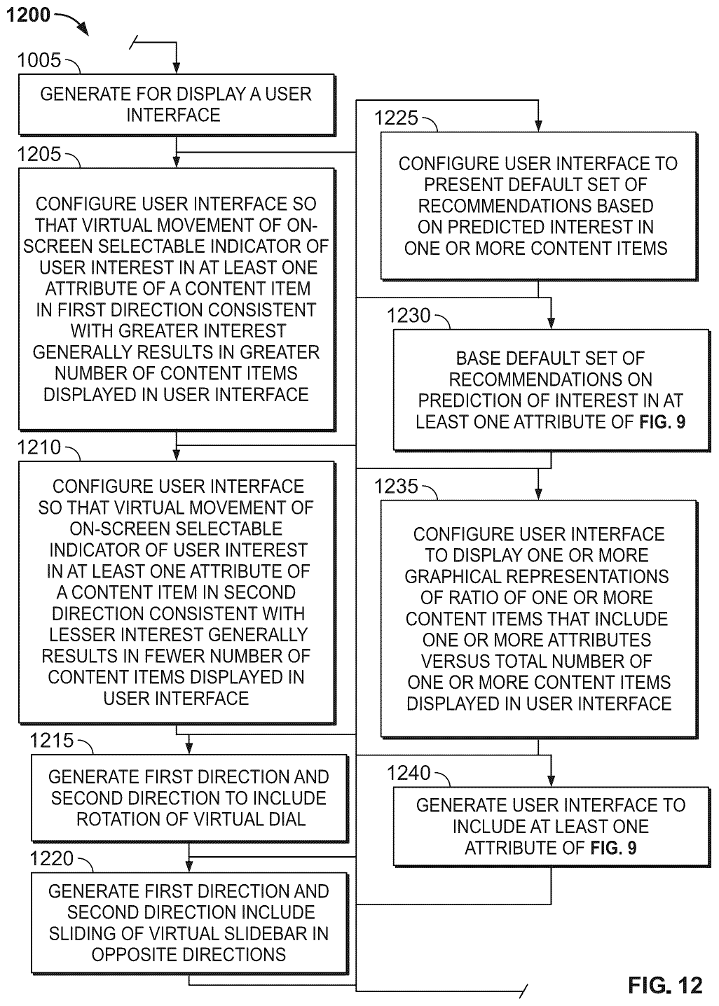

FIG. 11 depicts additional processes 1100 relating to the display of the GUIs 17, 37, 67, 97, 200, 300, 400, 600 according to an exemplary embodiment. The user interface is configured to display 1105 one or more graphical representations of a number of the one or more content items 1700 that include the one or more attributes 110-150, 905-955. The user interface is configured to display 1110 one or more graphical representations of a ratio of the one or more content items 1700 that include the one or more attributes 110-150, 905-955 versus a total number of the one or more content items 1700 displayed in the user interface. The at least one of the GUIs 17, 37, 67, 97, 200, 300, 400, or 600 is configured to display 1115 a converging plotline in which two or more attributes 110-150, 905-955 that were separate at a prior point in a timeline converge. The at least one of the GUIs 17, 37, 67, 97, 200, 300, 400, or 600 is configured to display 1120 a relationship between one or more convergences of one or more attributes 110-150, 905-955. The content recommendation (e.g., GUIs 17, 37, 67, 97, 200, 300, 400, 600) is generated 1125 with fuzzy logic based on user selection of preferences for a plurality of attributes 110-150, 905-955. The at least one of the GUIs 17, 37, 67, 97, 200, 300, 400, or 600 is configured to prompt 1130 input of a level of interest in one or more attributes 110-150, 905-955. The content recommendation (e.g., GUIs 17, 37, 67, 97, 200, 300, 400, 600) is provided 1135 in response to a selection of interest in one or more attributes 110-150, 905-955 greater than a predetermined threshold. The content recommendation (e.g., GUIs 17, 37, 67, 97, 200, 300, 400, 600) is provided 1140 in response to a determined relevance between one or more content items 1700 and one or more attributes 110-150, 905-955. The content recommendation (e.g., GUIs 17, 37, 67, 97, 200, 300, 400, 600) is provided 1145 based on a combination of a determination of a user interest in one or more content items 1700 and a determination of a relevance of the one or more content items 1700 to one or more attributes 110-150, 905-955.

FIG. 12 depicts additional processes 1200 relating to the display of the GUIs 17, 37, 67, 97, 200, 300, 400, 600 according to an exemplary embodiment. The user interface 400, 600 is configured 1205 so that virtual movement of an on-screen selectable indicator of user interest in at least one attribute 110-150, 905-995 of a content item 1703-1775 in a first direction consistent with greater interest generally results in a greater number of content items 1700 displayed in the user interface 400, 600. The user interface 400, 600 is configured 1210 so that virtual movement of the on-screen selectable indicator of the user interest in the least one attribute 110-150, 905-995 of the content item 1703-1775 in a second direction consistent with lesser interest generally results in a lesser number of content items 1700 displayed in the user interface 400, 600. In the generating step 1220, the first direction and the second direction include rotation of a virtual dial or sliding of a virtual slidebar in opposite directions.

The at least one of the GUIs 17, 37, 67, 97, 200, 300, 400, or 600 is configured 1225 to present a default set of recommendations based on a predicted interest in one or more content items 1700. The default set of recommendations is based 1230 on a prediction 1885 of interest in at least one of a title 905, a genre 910, a release date 915, a release decade 920, an MPAA rating 925, a critical rating 930, a season number 935, an episode number 940, a director 945, an actor 950, a character 955, a depicted object 960, a depicted setting 965, an actual setting 970, a type of action 975, a type of interaction 980, a plot origin point 985, or a plot end point 990.

The user interface is configured 1235 to display one or more graphical representations of a ratio of the one or more content items 1700 that include the one or more attributes 110-150, 905-955 versus a total number of the one or more content items 1700 displayed in the user interface. In the generating step 1240, the one or more attributes 110-150, 905-955 include at least one of a title 905, a genre 910, a release date 915, a release decade 920, an MPAA rating 925, a critical rating 930, a season number 935, an episode number 940, a director 945, an actor 950, a character 955, a depicted object 960, a depicted setting 965, an actual setting 970, a type of action 975, a type of interaction 980, a plot origin point 985, or a plot end point 990.

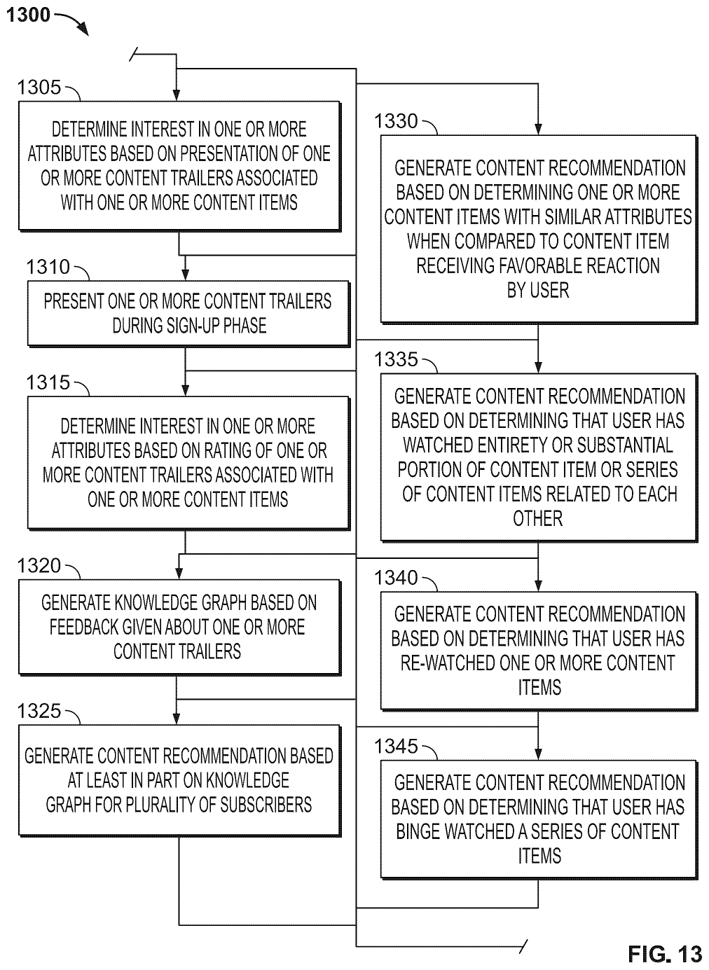

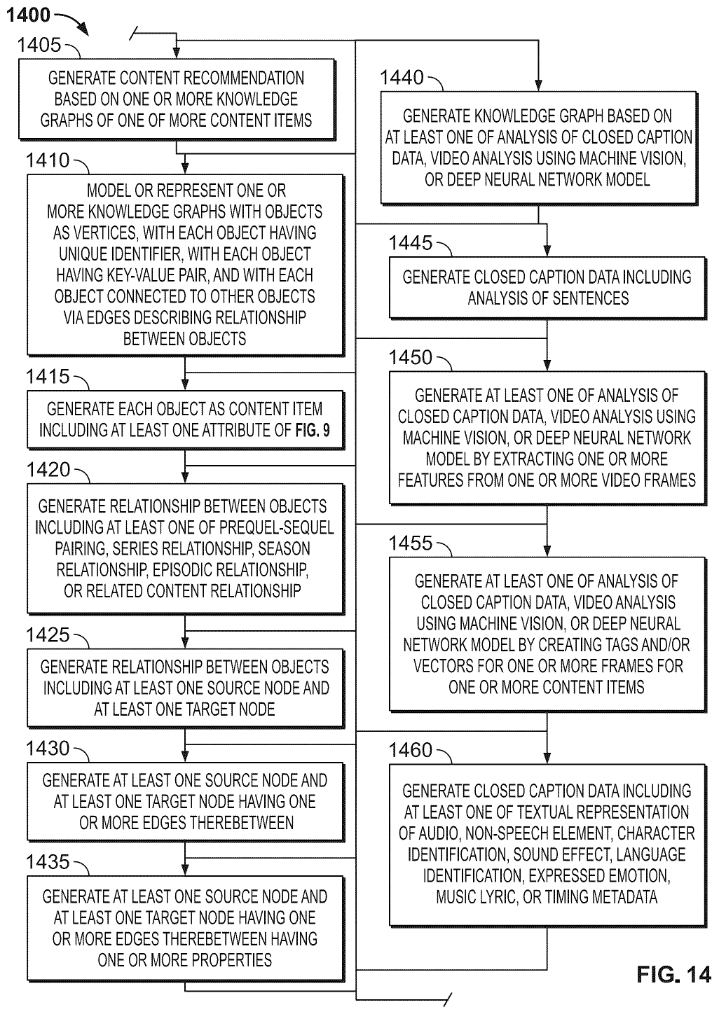

FIG. 13 depicts processes 1300 relating to determination of interest, generation of a knowledge graph (e.g., FIG. 7), and content recommendations (e.g., GUIs 17, 37, 67, 97, 200, 300, 400, 600) according to an exemplary embodiment. An interest in one or more attributes 110-150, 905-955 is determined 1305 based on a presentation of one or more content trailers associated with the one or more content items 1700. The one or more content trailers are presented 1310 during a sign-up phase. In some embodiments, an interest in one or more attributes 110-150, 905-955 is determined 1315 based on a rating (925, 930) of the one or more content trailers associated with the one or more content items 1700.

A knowledge graph (e.g., FIG. 7) is generated 1320 based on feedback given about one or more content trailers. The content recommendation (e.g., GUIs 17, 37, 67, 97, 200, 300, 400, 600) is generated 1325 based at least in part on the knowledge graph (e.g., FIG. 7) for a plurality of subscribers. In the generating step 1330, the content recommendation (e.g., GUIs 17, 37, 67, 97, 200, 300, 400, 600) is based on at least one of determining one or more content items 1700 with similar attributes 110-150, 905-955 when compared to a content item 1703-1775 receiving a favorable reaction by a user 5. In the generating step 1335, the content recommendation (e.g., GUIs 17, 37, 67, 97, 200, 300, 400, 600) is based on determining that a user 5 has watched an entirety or a substantial portion of a content item 1703-1775 or a series of content items 1700 related to each other. In the generating step 1340, the content recommendation (e.g., GUIs 17, 37, 67, 97, 200, 300, 400, 600) is based on determining that a user 5 has re-watched one or more content items 1700. In the generating step 1345, the content recommendation (e.g., GUIs 17, 37, 67, 97, 200, 300, 400, 600) is based on determining that a user 5 has binge-watched a series of content items 1700.

FIG. 14 depicts additional processes 1400 relating to content recommendations (e.g., GUIs 17, 37, 67, 97, 200, 300, 400, 600) and the knowledge graph (e.g., FIG. 7) according to an exemplary embodiment. In the generating step 1405, the content recommendation (e.g., GUIs 17, 37, 67, 97, 200, 300, 400, 600) is based on one or more knowledge graphs (e.g., FIG. 7) of one or more content items 1700. The one or more knowledge graphs (e.g., FIG. 7) are modeled or represented 1410 with objects as vertices, with each object having a unique identifier, with each object having a key-value pair, and with each object connected to other objects via edges describing a relationship between the objects. In the generating step 1415, each object is a content item 1703-1775 including at least one of a title 905, a genre 910, a release date 915, a release decade 920, an MPAA rating 925, a critical rating 930, a season number 935, an episode number 940, a director 945, an actor 950, a character 955, a depicted object 960, a depicted setting 965, an actual setting 970, a type of action 975, a type of interaction 980, a plot origin point 985, or a plot end point 990. In the generating step 1420, the relationship between the objects includes at least one of a prequel-sequel pairing, a series relationship, a season relationship, an episodic relationship, or a related content relationship. In the generating step 1425, the relationship between objects includes at least one source node and at least one target node. In the generating step 1430, each pair of the at least one source node and the at least one target node has one or more edges therebetween. In the generating step 1435, each edge has one or more properties.

In the generating step 1440, the knowledge graph (e.g., FIG. 7) is based on at least one of an analysis of closed caption data, a video analysis using machine vision, or a deep neural network model. In the generating step 1445, the closed caption data includes an analysis of sentences. In the generating step 1450, analysis of at least one of the closed caption data, the machine vision, or the deep neural network model extracts one or more features from one or more video frames. In the generating step 1455, analysis of at least one of the closed caption data, the machine vision, or the deep neural network model creates tags and/or vectors for one or more frames for the one or more content items 1700. In the generating step 1460, the closed caption data includes a textual representation of at least one of audio, a non-speech element, a character identification, a sound effect, a language identification, an expressed emotion, a music lyric, or timing metadata.

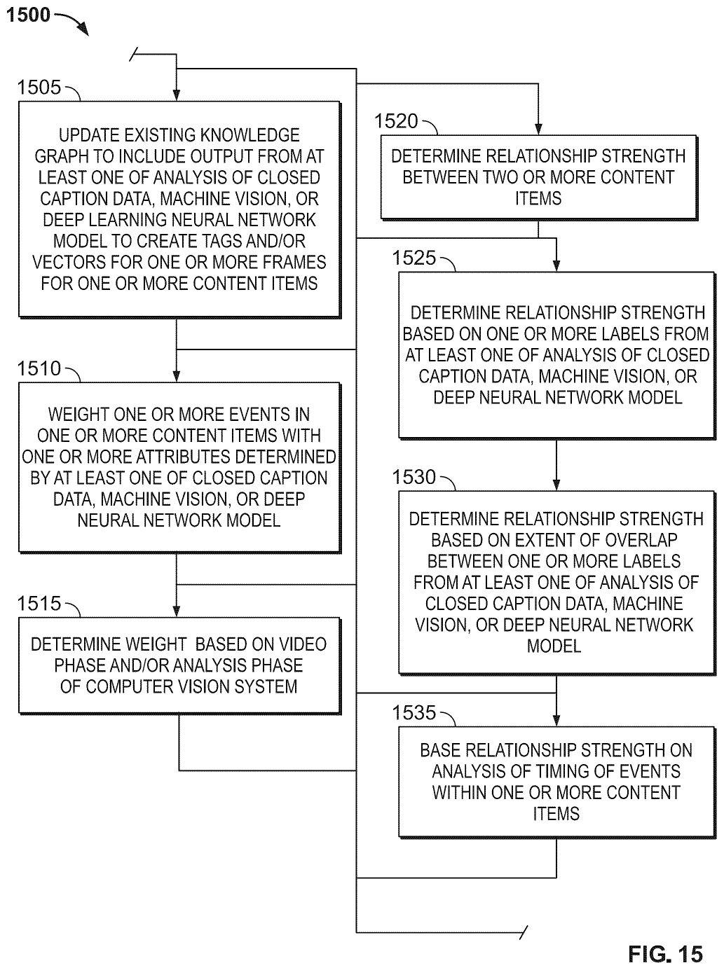

FIG. 15 depicts additional processes 1500 relating to the knowledge graph (e.g., FIG. 7), weightings, and determinations of relationship strength according to an exemplary embodiment. The process 1500 includes updating 1505 an existing knowledge graph (e.g., FIG. 7) to include output from the analysis of at least one of the closed caption data, the machine vision, or the deep neural network model to create tags and/or vectors for one or more frames for the one or more content items 1700. The process 1500 includes weighting 1510 one or more events in the one or more content items 1700 with one or more attributes 110-150, 905-955 determined by the analysis of at least one of the closed caption data, the machine vision, or the deep neural network model. The process 1500 includes determining 1515 weighting based on a video phase and/or an analysis phase of a computer vision system. The process 1500 includes determining 1520 a relationship strength between two or more content items 1700. Determining 1525 the relationship strength is based on one or more labels determined from the analysis of at least one of the closed caption data, the machine vision, or the deep neural network model. Determining 1530 the relationship strength is based on an extent of an overlap between the one or more labels determined from the analysis of at least one of the closed caption data, the machine vision, or the deep neural network model. The relationship strength is based 1535 on an analysis of a timing of events within the one or more content items 1700.

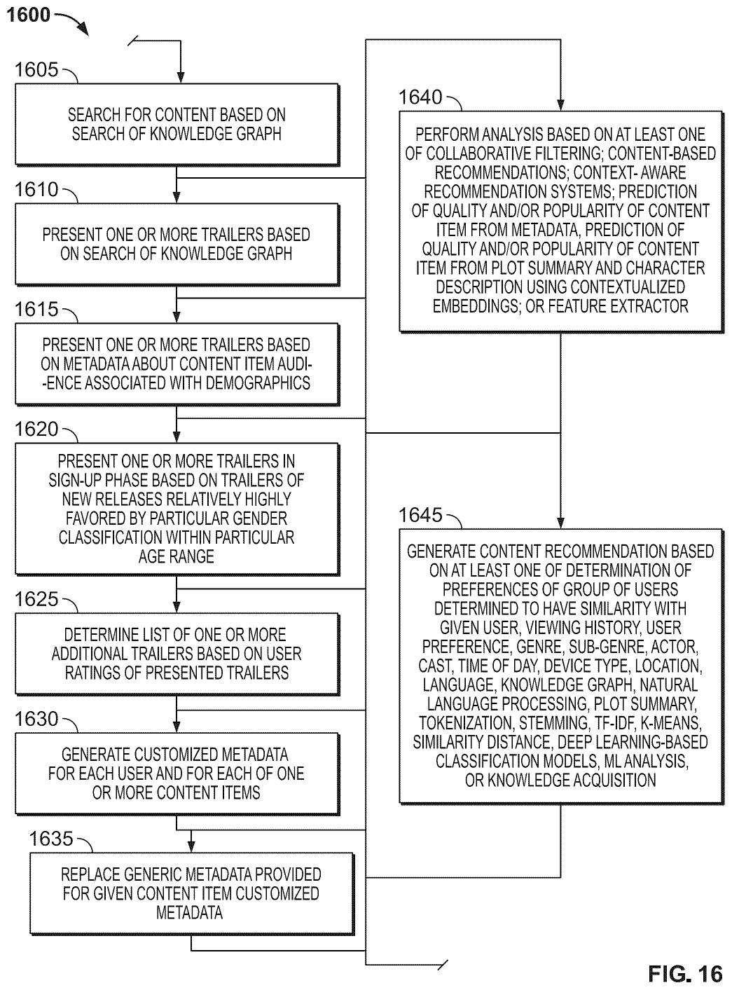

FIG. 16 depicts additional processes 1600 relating to uses of the knowledge graph (e.g., FIG. 7), trailers, metadata, types of analysis, and content recommendations (e.g., GUIs 17, 37, 67, 97, 200, 300, 400, 600) according to an exemplary embodiment. A search 1605 for content is based on a search of the knowledge graph (e.g., FIG. 7). One or more trailers are presented 1610 based on the search of the knowledge graph (e.g., FIG. 7). One or more trailers are presented 1615 based on metadata including demographics of an audience associated with certain content. One or more trailers are presented 1620 in a sign-up phase based on trailers of new releases relatively highly favored by a particular gender classification within a particular age range. A list of one or more additional trailers is determined 1625 based on user ratings of presented trailers. Customized metadata is generated 1630 for each user 5 and for each of the one or more content items 1700. The customized metadata replaces 1635 generic metadata provided for a given content item 1703-1775.

In the performing step 1640, analysis is based on at least one of collaborative filtering; content-based recommendations; context-aware recommendation systems; prediction 1885 of quality and/or popularity of a content item 1703-1775 from metadata, prediction 1885 of quality and/or popularity of a content item 1703-1775 from a plot summary and a character description using contextual information embedded into the metadata; or a feature extractor.

In the generating step 1645, the content recommendation (e.g., GUIs 17, 37, 67, 97, 200, 300, 400, 600) is based on at least one of a determination of preferences of a group of users determined to have similarity with a given user 5, the viewing history, the user preference, a genre 910, a sub-genre 910, an actor 950, a cast, a time of day, a device type, a location, a language, the knowledge graph (e.g., FIG. 7), natural language processing, a plot summary, tokenization, stemming, TF-IDF, K-means, similarity distance, deep learning-based classification models, ML analysis, or knowledge acquisition.

FIG. 17 depicts types of content items 1700 according to an exemplary embodiment. The content item 1703-1775 is at least one of an image 1703, a video 1706, a text 1709, audio 1712, audiovisual content 1715, electronic media 1718, audio-only content 1721, video-only content 1724, 2D content 1727, 3D content 1730, virtual reality content 1733, composite content 1736, user generated content 1739, a movie 1742, a program 1745, a segment 1748, a conference 1751, streaming content 1754, an advertisement 1757, live content 1760, a performance 1763, a broadcast 1766, pre-recorded content 1769, computer-generated content 1772, or animated content 1775.

A metadata module is provided that performs at least one metadata-related function of step 810, 815, 820, 1460, 1615, 1630, 1635, or 1640, and the like. An attribute module is provided that performs at least one attribute-related function of step 810, 815, 820, 830, 835, 1010, 1015, 1030, 1035, 1040, 1045, 1050, or 1060, and the like. A knowledge graph module is provided that performs at least one knowledge graph-related function of step 820, 825, 1320, 1325, 1405, 1410, 1460, 1505, 1605, 1610, or 1645, and the like. A timeline module is provided that performs at least one timeline-related function of step 1020, 1025, 1030, 1035, or 1115, and the like. A prediction module is provided that performs at least one prediction-related function of step 815, 1225, 1230, 1640, or 1885, and the like. A display module is provided that performs at least one display-related function of step 1005, 1010, 1020, 1025, 1030, 1040, 1045, 1050, 1060, 1105, 1110, 1115, 1120, 1205, 1210, or 1235, and the like. A recommendation module is provided that performs at least one recommendation-related function of step 835, 1125, 1135, 1140, 1145, 1225, 1230, 1325, 1330, 1335, 1340, 1345, 1405, 1640, or 1645, and the like. A search module is provided that performs at least one search-related function of step 1010, 1605, or 1610, and the like. A content item module is provided that performs at least one content item-related function of step 810, 815, 820, 825, 830, 1010, 1020, 1025, 1040, 1045, 1050, 1055, 1060, 1105, 1110, 1140, or 1145, and the like. A plot module is provided that performs at least one plot function of step 1025, 1115, 1640, or 1645, and the like. A user interface module is provided that performs at least one user interface-related function of step 1005, 1015, 1110, 1205, 1205, 1210, 1225, 1235, or 1240, and the like. A model module is provided that performs at least one model-related function of step 1410-1460, 1505-1535, or 1645, and the like. See predictive model 1850 (FIG. 8). At least one module and/or at least one model may be provided separately or combined in any suitable arrangement in at least one of computing device 1902, display device 1910, server 1904, or communication network 1906.

Predictive Model

Throughout the present disclosure, determinations, predictions, likelihoods, user interest, relatedness, and the like are determined with one or more predictive models. For example, FIG. 18 depicts a predictive model, which performs analysis based on at least one of hard rules, learning rules, hard models, learning models, usage data, load data, analytics of the same, metadata, or profile information, and the like. A prediction process 1800 includes a predictive model 1850 in some embodiments. The predictive model 1850 receives as input various forms of data about one, more or all the users, media content items, devices, and data described in the present disclosure. The predictive model 1850 performs analysis based on at least one of hard rules, learning rules, hard models, learning models, usage data, load data, analytics of the same, metadata, or profile information, and the like. The predictive model 1850 outputs one or more predictions of a future state of any of the devices described in the present disclosure. A load-increasing event is determined by load-balancing techniques, e.g., least connection, least bandwidth, round robin, server response time, weighted versions of the same, resource-based techniques, and address hashing. The predictive model 1850 is based on input including at least one of a hard rule 1805, a user-defined rule 1810, a rule defined by a content provider 1815, a hard model 1820, or a learning model 1825.

The predictive model 1850 receives as input usage data 1830. The predictive model 1850 is based on at least one of a usage pattern of the user or media device, a usage pattern of the requesting media device, a usage pattern of the media content item, a usage pattern of the communication system or network, a usage pattern of the profile, or a usage pattern of the currently streaming media device.

The predictive model 1850 receives as input load-balancing data 1835. The predictive model 1850 is based on at least one of load data of the display device, load data of the requesting media device, load data of the media content item, load data of the communication system or network, load data of the profile, or load data of the currently streaming media device.

The predictive model 1850 receives as input metadata 1840. The predictive model 1850 is based on at least one of metadata of the streaming service, metadata of the requesting media device, metadata of the media content item, metadata of the communication system or network, metadata of the profile, or metadata of the currently streaming media device. The metadata includes information of the type represented in the media device manifest.

The predictive model 1850 is trained with data. The training data is developed in some embodiments using one or more data techniques including but not limited to data selection, data sourcing, and data synthesis. The predictive model 1850 is trained in some embodiments with one or more analytical techniques including but not limited to classification and regression trees (CART), discrete choice models, linear regression models, logistic regression, logit versus probit, multinomial logistic regression, multivariate adaptive regression splines, probit regression, regression techniques, survival or duration analysis, and time series models. The predictive model 1850 is trained in some embodiments with one or more machine learning approaches including but not limited to supervised learning, unsupervised learning, semi-supervised learning, reinforcement learning, and dimensionality reduction. The predictive model 1850 in some embodiments includes regression analysis including analysis of variance (ANOVA), linear regression, logistic regression, ridge regression, and/or time series. The predictive model 1850 in some embodiments includes classification analysis including decision trees and/or neural networks. In FIG. 18, a depiction of a multi-layer neural network is provided as a non-limiting, exemplary predictive model 1850, the exemplary neural network including an input layer (left side), three hidden layers (middle), and an output layer (right side) with 32 neurons and 192 edges, which is intended to be illustrative, not limiting. The predictive model 1850 is based on data engineering and/or modeling techniques. The data engineering techniques include exploration, cleaning, normalizing, feature engineering, and scaling. The modeling techniques include model selection, training, evaluation, and tuning. The predictive model 1850 is operationalized using registration, deployment, monitoring, and/or retraining techniques.

The predictive model 1850 is configured to output a current state 1881, and/or a future state 1883, and/or a determination, a prediction, a likelihood, a level of user interestedness, a relatedness 1885, and the like.

The predictive model 1850 is configured to output the current state 1881, and/or the future state 1883, and/or the determination, the prediction, the likelihood, the level of user interestedness, the relatedness 1885, and the like, which may be applied to at least one of the GUIs 17, 37, 67, 97, 200, 300, 400, or 600, processes 800, 1000, 1100, 1200, 1300, 1400, 1500, or 1600 (including one or more of the various subprocesses thereof), or the system 1900 (including one or more of the various components thereof).

A system 1900 is provided comprising control circuitry (e.g., 1908, 1934) configured to perform one, more, or all of the features, processes, and methods described above. The system 1900 is configured to determine whether the current state 1881, and/or the future state 1883, and/or the determination, the prediction, the likelihood, the level of user interestedness, the relatedness 1885, and the like, satisfies a standard 1890. Based on whether the standard is satisfied 1890, a signal is outputted such as OK/Not OK, Go/No Go, Yes/No, and the like.

A non-transitory, computer-readable medium having non-transitory, computer-readable instructions encoded thereon is provided that, when executed by control circuitry (e.g., 1908, 1934), cause the control circuitry to perform one, more, or all of the features, processes, and methods described above. A device (e.g., 1902, 1904) is provided including means for performing one, more, or all of the features described above.

Communication System

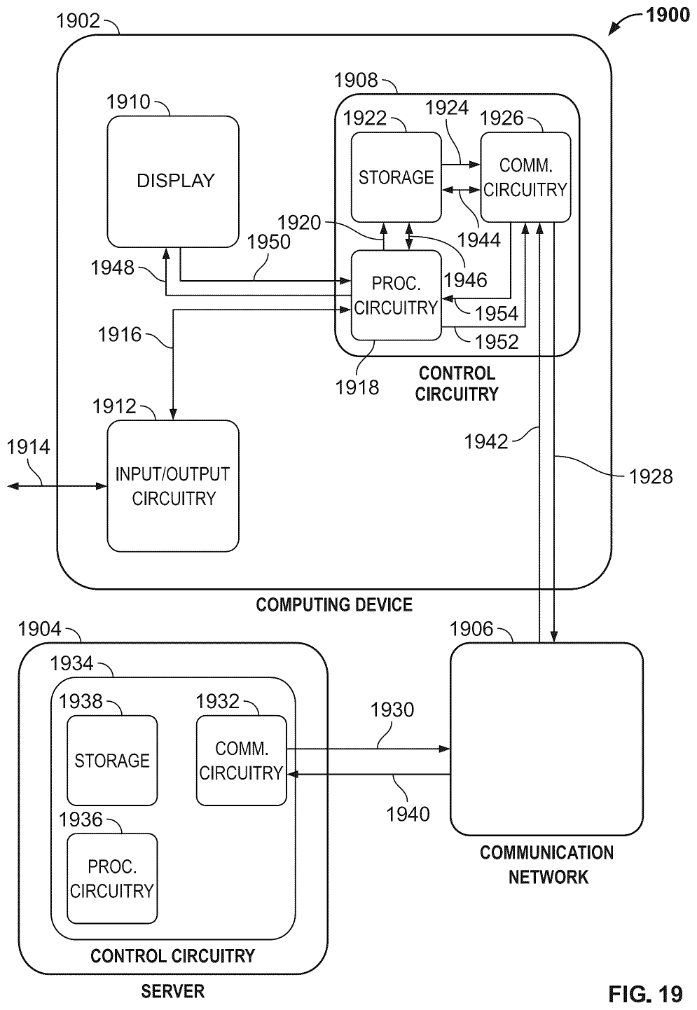

The system 1900 for delivery of media content includes delivery of the media content from a content provider to a media device through a communication system or network 1906 (FIG. 19). The system 1900 includes control circuitry (e.g., 1908, 1934). The control circuitry 1902, 1934 is configured to perform one, more, or all the features of the methods referenced herein in any suitable combination.

A non-transitory, computer-readable medium having non-transitory, computer-readable instructions encoded thereon is provided. The non-transitory, computer-readable medium is provided for controlling delivery of media content from a content provider to a media device, through a communication system or network 1906. The instructions, when executed by control circuitry 1902, 1934, may cause the control circuitry 1902, 1934 to perform one, more, or all the features referenced herein of the methods, processes, and outputs of one or more of FIGS. 1A-18 in any suitable combination.

A device is configured for controlling delivery of media content. The device includes means for performing one, more, or all the features referenced herein of the methods, processes, and outputs of one or more of FIGS. 1A-18 in any suitable combination. The device is at least one of a server 1855, a smartphone (not shown), a tablet 1860, a network-connected computer 1870, user equipment, a media device 1875, or a computing device 1880.

FIG. 19 depicts a block diagram representing exemplary media content delivery control system 1900, in accordance with some embodiments. The system is shown to include computing device 1902, server 1904, and a communication network 1906. It is understood that while a single instance of a component may be shown and described relative to FIG. 19, additional instances of the component may be employed. For example, server 1904 may include, or may be incorporated in, more than one server. Similarly, communication network 1906 may include, or may be incorporated in, more than one communication network. Server 1904 is shown communicatively coupled to computing device 1902 through communication network 1906. While not shown in FIG. 19, server 1904 may be directly communicatively coupled to computing device 1902, for example, in a system absent or bypassing communication network 1906.

Communication network 1906 may include one or more network systems, such as, without limitation, the Internet, LAN, Wi-Fi, or other network systems suitable for audio processing applications. The system 1900 of FIG. 19 excludes server 1904, and functionality that would otherwise be implemented by server 1904 is instead implemented by other components of the system depicted by FIG. 19, such as one or more components of communication network 1906. In still other embodiments, server 1904 works in conjunction with one or more components of communication network 1906 to implement certain functionality described herein in a distributed or cooperative manner. Similarly, The system depicted by FIG. 19 excludes computing device 1902, and functionality that would otherwise be implemented by computing device 1902 is instead implemented by other components of the system depicted by FIG. 19, such as one or more components of communication network 1906 or server 1904 or a combination of the same. In other embodiments, computing device 1902 works in conjunction with one or more components of communication network 1906 or server 1904 to implement certain functionality described herein in a distributed or cooperative manner.

Computing device 1902 includes control circuitry 1908, display 1910 and input/output (I/O) circuitry 1912. Control circuitry 1908 may be based on any suitable processing circuitry and includes control circuits and memory circuits, which may be disposed on a single integrated circuit or may be discrete components. As referred to herein, processing circuitry should be understood to mean circuitry based on at least one microprocessors, microcontrollers, digital signal processors, programmable logic devices, field-programmable gate arrays (FPGAs), or application-specific integrated circuits (ASICs), etc., and may include a multi-core processor (e.g., dual-core, quad-core, hexa-core, or any suitable number of cores). In some embodiments, processing circuitry may be distributed across multiple separate processors or processing units, for example, multiple of the same type of processing units (e.g., two Intel Core i7 processors) or multiple different processors (e.g., an Intel Core i5 processor and an Intel Core i7 processor). Some control circuits may be implemented in hardware, firmware, or software. Control circuitry 1908 in turn includes communication circuitry 1926, storage 1922 and processing circuitry 1918. Either of control circuitry 1908 and 1934 may be utilized to execute or perform any or all the methods, processes, and outputs of one or more of FIGS. 1A-18, or any combination of steps thereof (e.g., as enabled by processing circuitries 1918 and 1936, respectively).

In addition to control circuitry 1908 and 1934, computing device 1902 and server 1904 may each include storage (storage 1922, and storage 1938, respectively). Each of storages 1922 and 1938 may be an electronic storage device. As referred to herein, the phrase “electronic storage device” or “storage device” should be understood to mean any device for storing electronic data, computer software, or firmware, such as random-access memory, read-only memory, hard drives, optical drives, digital video disc (DVD) recorders, compact disc (CD) recorders, BLU-RAY disc (BD) recorders, BLU-RAY 8D disc recorders, digital video recorders (DVRs, sometimes called personal video recorders, or PVRs), solid state devices, quantum storage devices, gaming consoles, gaming media, or any other suitable fixed or removable storage devices, and/or any combination of the same. Each of storage 1922 and 1938 may be used to store various types of content, metadata, and/or other types of data (e.g., they are used to record audio questions asked by one or more participants connected to a conference). Non-volatile memory may also be used (e.g., to launch a boot-up routine and other instructions). Cloud-based storage may be used to supplement storages 1922 and 1938 or instead of storages 1922 and 1938. In some embodiments, a user profile and messages corresponding to a chain of communication may be stored in one or more of storages 1922 and 1938. Each of storages 1922 and 1938 may be utilized to stored commands on behalf of the QSA, for example, such that when each of processing circuitries 1918 and 1936, respectively, are prompted through control circuitries 1908 and 1934, respectively, either of processing circuitries 1918 or 1936 may execute any of the methods, processes, and outputs of one or more of FIGS. 1A-18, or any combination of steps thereof.

In some embodiments, control circuitry 1908 and/or 1934 executes instructions for an application stored in memory (e.g., storage 1922 and/or storage 1938). Specifically, control circuitry 1908 and/or 1934 may be instructed by the application to perform the functions discussed herein. In some embodiments, any action performed by control circuitry 1908 and/or 1934 may be based on instructions received from the application. For example, the application may be implemented as software or a set of and/or one or more executable instructions that may be stored in storage 1922 and/or 1938 and executed by control circuitry 1908 and/or 1934. The application may be a client/server application where only a client application resides on computing device 1902, and a server application resides on server 1904.

The application may be implemented using any suitable architecture. For example, it may be a stand-alone application wholly implemented on computing device 1902. In such an approach, instructions for the application are stored locally (e.g., in storage 1922), and data for use by the application is downloaded on a periodic basis (e.g., from an out-of-band feed, from an Internet resource, or using another suitable approach). Control circuitry 1908 may retrieve instructions for the application from storage 1922 and process the instructions to perform the functionality described herein. Based on the processed instructions, control circuitry 1908 may determine a type of action to perform in response to input received from I/O circuitry 1912 or from communication network 1906.

In client/server-based embodiments, control circuitry 1908 may include communication circuitry suitable for communicating with an application server (e.g., server 1904) or other networks or servers. The instructions for carrying out the functionality described herein may be stored on the application server. Communication circuitry may include a cable modem, an Ethernet card, or a wireless modem for communication with other equipment, or any other suitable communication circuitry. Such communication may involve the Internet or any other suitable communication networks or paths (e.g., communication network 1906). In another example of a client/server-based application, control circuitry 1908 runs a web browser that interprets web pages provided by a remote server (e.g., server 1904). For example, the remote server may store the instructions for the application in a storage device.

The remote server may process the stored instructions using circuitry (e.g., control circuitry 1934) and/or generate displays. Computing device 1902 may receive the displays generated by the remote server and may display the content of the displays locally via display 1910. For example, display 1910 may be utilized to present a string of characters. This way, the processing of the instructions is performed remotely (e.g., by server 1904) while the resulting displays, such as the display windows described elsewhere herein, are provided locally on computing device 1904. Computing device 1902 may receive inputs from the user via input/output circuitry 1912 and transmit those inputs to the remote server for processing and generating the corresponding displays.

Alternatively, computing device 1902 may receive inputs from the user via input/output circuitry 1912 and process and display the received inputs locally, by control circuitry 1908 and display 1910, respectively. For example, input/output circuitry 1912 may correspond to a keyboard and/or a set of and/or one or more speakers/microphones which are used to receive user inputs (e.g., input as displayed in a search bar or a display of FIG. 19 on a computing device). Input/output circuitry 1912 may also correspond to a communication link between display 1910 and control circuitry 1908 such that display 1910 updates in response to inputs received via input/output circuitry 1912 (e.g., simultaneously update what is shown in display 1910 based on inputs received by generating corresponding outputs based on instructions stored in memory via a non-transitory, computer-readable medium).

Server 1904 and computing device 1902 may transmit and receive content and data such as media content via communication network 1906. For example, server 1904 may be a media content provider, and computing device 1902 may be a smart television configured to download or stream media content, such as a live news broadcast, from server 1904. Control circuitry 1934, 1908 may send and receive commands, requests, and other suitable data through communication network 1906 using communication circuitry 1932, 1926, respectively. Alternatively, control circuitry 1934, 1908 may communicate directly with each other using communication circuitry 1932, 1926, respectively, avoiding communication network 1906.

It is understood that computing device 1902 is not limited to the embodiments and methods shown and described herein. In nonlimiting examples, computing device 1902 may be a television, a Smart TV, a set-top box, an integrated receiver decoder (IRD) for handling satellite television, a digital storage device, a digital media receiver (DMR), a digital media adapter (DMA), a streaming media device, a DVD player, a DVD recorder, a connected DVD, a local media server, a BLU-RAY player, a BLU-RAY recorder, a personal computer (PC), a laptop computer, a tablet computer, a WebTV box, a personal computer television (PC/TV), a PC media server, a PC media center, a handheld computer, a stationary telephone, a personal digital assistant (PDA), a mobile telephone, a portable video player, a portable music player, a portable gaming machine, a smartphone, or any other device, computing equipment, or wireless device, and/or combination of the same, capable of suitably displaying and manipulating media content.

Computing device 1902 receives user input 1914 at input/output circuitry 1912. For example, computing device 1902 may receive a user input such as a user swipe or user touch. It is understood that computing device 1902 is not limited to the embodiments and methods shown and described herein.

User input 1914 may be received from a user selection-capturing interface that is separate from device 1902, such as a remote-control device, trackpad, or any other suitable user movement-sensitive, audio-sensitive or capture devices, or as part of device 1902, such as a touchscreen of display 1910. Transmission of user input 1914 to computing device 1902 may be accomplished using a wired connection, such as an audio cable, USB cable, ethernet cable and the like attached to a corresponding input port at a local device, or may be accomplished using a wireless connection, such as Bluetooth, Wi-Fi, WiMAX, GSM, UTMS, CDMA, TDMA, 8G, 4G, 4G LTE, 5G, or any other suitable wireless transmission protocol. Input/output circuitry 1912 may include a physical input port such as a 12.5 mm (0.4921 inch) audio jack, RCA audio jack, USB port, ethernet port, or any other suitable connection for receiving audio over a wired connection or may include a wireless receiver configured to receive data via Bluetooth, Wi-Fi, WiMAX, GSM, UTMS, CDMA, TDMA, 3G, 4G, 4G LTE, 5G, or other wireless transmission protocols.

Processing circuitry 1918 may receive user input 1914 from input/output circuitry 1912 using communication path 1916. Processing circuitry 1918 may convert or translate the received user input 1914 that may be in the form of audio data, visual data, gestures, or movement to digital signals. In some embodiments, input/output circuitry 1912 performs the translation to digital signals. In some embodiments, processing circuitry 1918 (or processing circuitry 1936, as the case may be) carries out disclosed processes and methods.

Processing circuitry 1918 may provide requests to storage 1922 by communication path 1920. Storage 1922 may provide requested information to processing circuitry 1918 by communication path 1946. Storage 1922 may transfer a request for information to communication circuitry 1926 which may translate or encode the request for information to a format receivable by communication network 1906 before transferring the request for information by communication path 1928. Communication network 1906 may forward the translated or encoded request for information to communication circuitry 1932, by communication path 1930.

At communication circuitry 1932, the translated or encoded request for information, received through communication path 1930, is translated or decoded for processing circuitry 1936, which will provide a response to the request for information based on information available through control circuitry 1934 or storage 1938, or a combination thereof. The response to the request for information is then provided back to communication network 1906 by communication path 1940 in an encoded or translated format such that communication network 1906 forwards the encoded or translated response back to communication circuitry 1926 by communication path 1942.

At communication circuitry 1926, the encoded or translated response to the request for information may be provided directly back to processing circuitry 1918 by communication path 1954 or may be provided to storage 1922 through communication path 1944, which then provides the information to processing circuitry 1918 by communication path 1946. Processing circuitry 1918 may also provide a request for information directly to communication circuitry 1926 through communication path 1952, where storage 1922 responds to an information request (provided through communication path 1920 or 1944) by communication path 1924 or 1946 that storage 1922 does not contain information pertaining to the request from processing circuitry 1918.

Processing circuitry 1918 may process the response to the request received through communication paths 1946 or 1954 and may provide instructions to display 1910 for a notification to be provided to the users through communication path 1948. Display 1910 may incorporate a timer for providing the notification or may rely on inputs through input/output circuitry 1912 from the user, which are forwarded through processing circuitry 1918 through communication path 1948, to determine how long or in what format to provide the notification. When display 1910 determines the display has been completed, a notification may be provided to processing circuitry 1918 through communication path 1950.

The communication paths provided in FIG. 19 between computing device 1902, server 1904, communication network 1906, and all subcomponents depicted are exemplary and may be modified to reduce processing time or enhance processing capabilities for each step in the processes disclosed herein by one skilled in the art.

This specification discloses embodiments, which include, but are not limited to, the following items:

Items:

1. A method for providing content recommendations from among a plurality of content items (3, 61, 89, 100, 220-240, 350, 360, 461-483, 705-750, 1700, 1703-1775, 1865), the method (800) comprising: accessing a knowledge graph (700, including a knowledge graph based on attributes 900) of a content item (3, 61, 89, 100, 220-240, 350, 360, 461-483, 705-750, 1700, 1703-1775, 1865), the knowledge graph (700, including a knowledge graph based on attributes 900) based on at least one of an attributes (110-150, 760-790b, 900, 905-995) of the content item (3, 61, 89, 100, 220-240, 350, 360, 461-483, 705-750, 1700, 1703-1775, 1865), metadata (1840) regarding the content item (3, 61, 89, 100, 220-240, 350, 360, 461-483, 705-750, 1700, 1703-1775, 1865), a viewing history, a user preference determined by analysis, or a user preference selected associated with a user device (3, 1902); selecting one or more attributes of interest from a plurality of attributes of the content item (3, 61, 89, 100, 220-240, 350, 360, 461-483, 705-750, 1700, 1703-1775, 1865); and generating a content recommendation based on the selected one or more attributes of interest.

2. The method (800) of item 1, wherein the user preference determined by analysis is determined based on an analysis of at least one of the attributes (110-150, 760-790b, 900, 905-995) of the content item (3, 61, 89, 100, 220-240, 350, 360, 461-483, 705-750, 1700, 1703-1775, 1865), the metadata (1840) of the content item (3, 61, 89, 100, 220-240, 350, 360, 461-483, 705-750, 1700, 1703-1775, 1865), the viewing history, or the user preference selected by the user device.

3. The method (800) of item 1, wherein the content recommendation only includes portions of one or more original content items that include the selected one or more attributes of interest.

4. The method (800) of item 1, wherein the content recommendation only includes one or more content items (3, 61, 89, 100, 220-240, 350, 360, 461-483, 705-750, 1700, 1703-1775, 1865) that include the selected one or more attributes of interest.

5. The method (800) of item 1, further comprising determining a prediction of likely interest in one or more content items (3, 61, 89, 100, 220-240, 350, 360, 461-483, 705-750, 1700, 1703-1775, 1865) based on the analysis of the one or more of the attributes (110-150, 760-790b, 900, 905-995) of the content item (3, 61, 89, 100, 220-240, 350, 360, 461-483, 705-750, 1700, 1703-1775, 1865), the metadata (1840) of the content item (3, 61, 89, 100, 220-240, 350, 360, 461-483, 705-750, 1700, 1703-1775, 1865), and the user preference selected by the user device.

6. The method (800) of item 1, wherein the attributes (110-150, 760-790b, 900, 905-995) is at least one of a title (710, 725, 740, 755, 905), a genre (910), a release date (915), a release decade (920), an MPAA rating (925), a critical rating (930), a season number (935), an episode number (940), a director (945), an actor (950), a character (955), a depicted object (960), a depicted setting (965), an actual setting (970), a type of action (975), a type of interaction (980), a plot origin point (985), or a plot end point (990).

7. The method (800) of item 1, further comprising generating for display a user interface (17, 37, 67, 97, 300, 400, 600) with one or more options to search (1010) one or more content items (3, 61, 89, 100, 220-240, 350, 360, 461-483, 705-750, 1700, 1703-1775, 1865) based on the selected one or more attributes of interest.

8. The method (800) of item 1, further comprising generating for display a user interface (17, 37, 67, 97, 300, 400, 600), wherein the user interface (17, 37, 67, 97, 300, 400, 600) changes in response to selections of one or more values and/or weights of the one or more attributes of interest.

9. The method (800) of item 1, further comprising generating for display a user interface (17, 37, 67, 97, 300, 400, 600), wherein the user interface (17, 37, 67, 97, 300, 400, 600) is configured to display a timeline referencing the one or more content items (3, 61, 89, 100, 220-240, 350, 360, 461-483, 705-750, 1700, 1703-1775, 1865).

10. The method (800) of item 9, wherein the timeline is a series of occurrences in the one or more content items (3, 61, 89, 100, 220-240, 350, 360, 461-483, 705-750, 1700, 1703-1775, 1865) that form a plot or part of a plot of the one or more content items (3, 61, 89, 100, 220-240, 350, 360, 461-483, 705-750, 1700, 1703-1775, 1865).

11. The method (800) of item 9, wherein the attributes (110-150, 760-790b, 900, 905-995) includes the timeline or a combination of one or more attributes (110-150, 760-790b, 900, 905-995) and the timeline.

12. The method (800) of item 9, wherein the one or more attributes (110-150, 760-790b, 900, 905-995) are mapped along the timeline.

13. The method (800) of item 1, wherein the content item (3, 61, 89, 100, 220-240, 350, 360, 461-483, 705-750, 1700, 1703-1775, 1865) is at least one of an image (1703), a video (1706), a text (1709), audio (1712), audiovisual content (1715), video-only content (1724), 2D content (1727), 3D content (1730), virtual reality content (1733), composite content (1736), user generated content (1739), a movie (1742), a program (1745), a segment (1748), a conference (1751), streaming content (1754), an advertisement (1757), live content (1760), a performance (1763), a broadcast (1766), pre-recorded content (1769), computer-generated content (1772), or animated content (1775).

14. The method (800) of item 1, further comprising generating for display a user interface (17, 37, 67, 97, 300, 400, 600), wherein the user interface (17, 37, 67, 97, 300, 400, 600) is configured to display each of the one or more content items (3, 61, 89, 100, 220-240, 350, 360, 461-483, 705-750, 1700, 1703-1775, 1865) as a graphical object including within the graphical object one or more symbols corresponding to the one or more attributes (110-150, 760-790b, 900, 905-995).

15. The method (800) of item 1, wherein an attributes (110-150, 760-790b, 900, 905-995) in common between two or more content items (3, 61, 89, 100, 220-240, 350, 360, 461-483, 705-750, 1700, 1703-1775, 1865) is displayed with a same symbol for the attributes (110-150, 760-790b, 900, 905-995) in common.

16. The method (800) of item 1, further comprising generating for display a user interface (17, 37, 67, 97, 300, 400, 600), wherein the user interface (17, 37, 67, 97, 300, 400, 600) is configured to display a relationship indicator (760, 765, 770a, 775a, 780, 785, 790a) representing a relationship between two or more content items sharing at least one attribute in common.

17. The method (800) of item 1, further comprising generating for display a user interface (17, 37, 67, 97, 300, 400, 600), wherein the user interface (17, 37, 67, 97, 300, 400, 600) is configured to display a plurality of content items (3, 61, 89, 100, 220-240, 350, 360, 461-483, 705-750, 1700, 1703-1775, 1865) including one or more content items of lesser relative interest that do not have the selected one or more attributes of interest and one or more content items of greater relative interest that have the selected one or more attributes of interest, and wherein the one or more content items of greater relative interest are highlighted or depicted with a different graphical effect compared to the one or more content items of lesser relative interest (see FIGS. 1I-6).

18. The method (800) of item 1, further comprising generating for display a user interface (17, 37, 67, 97, 300, 400, 600), wherein the user interface (17, 37, 67, 97, 300, 400, 600) is configured to display one or more symbols representing the one or more attributes (110-150, 760-790b, 900, 905-995) of the one or more content items (3, 61, 89, 100, 220-240, 350, 360, 461-483, 705-750, 1700, 1703-1775, 1865) (see FIGS. 1I-6).

19. The method (800) of item 1, further comprising generating for display a user interface (17, 37, 67, 97, 300, 400, 600), wherein the user interface (17, 37, 67, 97, 300, 400, 600) is configured to display one or more graphical representations of a number of the one or more content items (3, 61, 89, 100, 220-240, 350, 360, 461-483, 705-750, 1700, 1703-1775, 1865) that include the one or more attributes (110-150, 760-790b, 900, 905-995) (see FIGS. 1I-6).

20. The method (800) of item 1, further comprising generating for display a user interface (17, 37, 67, 97, 300, 400, 600), wherein the user interface (17, 37, 67, 97, 300, 400, 600) is configured to display one or more graphical representations of a ratio of the one or more content items (3, 61, 89, 100, 220-240, 350, 360, 461-483, 705-750, 1700, 1703-1775, 1865) that include the one or more attributes (110-150, 760-790b, 900, 905-995) versus a total number of the one or more content items (3, 61, 89, 100, 220-240, 350, 360, 461-483, 705-750, 1700, 1703-1775, 1865) displayed in the user interface (17, 37, 67, 97, 300, 400, 600) (see FIGS. 4-6).

21. The method (800) of item 1, further comprising generating for display a user interface (17, 37, 67, 97, 300, 400, 600), wherein the user interface (17, 37, 67, 97, 300, 400, 600) is configured to display a converging plotline in which two or more attributes (110) that were separate at a prior point in a timeline converge (see FIG. 3).

22. The method (800) of item 1, further comprising generating for display a user interface (17, 37, 67, 97, 300, 400, 600), wherein the user interface (17, 37, 67, 97, 300, 400, 600) is configured to display a relationship between one or more convergences of one or more attributes (110-150, 760-790b, 900, 905-995) (see FIGS. 3-6).

23. The method (800) of item 1, wherein the content recommendation is generated with fuzzy logic based on user selection of preferences for a plurality of attributes (see FIGS. 4-6).

24. The method (800) of item 1, further comprising generating for display a user interface (17, 37, 67, 97, 300, 400, 600), wherein the user interface (17, 37, 67, 97, 300, 400, 600) is configured to prompt input of a level of interest in one or more attributes (110-150, 760-790b, 900, 905-995) (see FIGS. 4-6).

25. The method (800) of item 1, wherein the content recommendation is provided in response to a selection of interest in one or more attributes (110-150, 760-790b, 900, 905-995) greater than a predetermined threshold.

26. The method (800) of item 1, wherein the content recommendation is provided in response to a determined relevance between one or more content items (3, 61, 89, 100, 220-240, 350, 360, 461-483, 705-750, 1700, 1703-1775, 1865) and one or more attributes (110-150, 760-790b, 900, 905-995).

27. The method (800) of item 1, wherein the content recommendation is based on a combination of a determination of a user interest in one or more content items (3, 61, 89, 100, 220-240, 350, 360, 461-483, 705-750, 1700, 1703-1775, 1865) and a determination of a relevance of the one or more content items (3, 61, 89, 100, 220-240, 350, 360, 461-483, 705-750, 1700, 1703-1775, 1865) to one or more attributes (110-150, 760-790b, 900, 905-995).

28. The method (800) of item 1, further comprising generating for display a user interface (17, 37, 67, 97, 300, 400, 600), wherein the user interface (17, 37, 67, 97, 300, 400, 600) is configured so that virtual movement of an on-screen selectable indicator of user interest in at least one attribute of a content item (3, 61, 89, 100, 220-240, 350, 360, 461-483, 705-750, 1700, 1703-1775, 1865) in a first direction consistent with greater interest generally results in a greater number of content items (3, 61, 89, 100, 220-240, 350, 360, 461-483, 705-750, 1700, 1703-1775, 1865) displayed in the user interface (17, 37, 67, 97, 300, 400, 600), and virtual movement of the on-screen selectable indicator of the user interest in the least one attribute (110) of the content item (3, 61, 89, 100, 220-240, 350, 360, 461-483, 705-750, 1700, 1703-1775, 1865) in a second direction consistent with lesser interest generally results in a lesser number of content items (3, 61, 89, 100, 220-240, 350, 360, 461-483, 705-750, 1700, 1703-1775, 1865) displayed in the user interface (17, 37, 67, 97, 300, 400, 600) (see FIGS. 4-6).

29. The method (800) of item 28, wherein the first direction and the second direction include rotation of a virtual dial or sliding of a virtual slidebar in opposite directions (see FIGS. 4-6).

30. The method (800) of item 1, further comprising generating for display a user interface (17, 37, 67, 97, 300, 400, 600), wherein the user interface (17, 37, 67, 97, 300, 400, 600) is configured to present a default set of recommendations based on a predicted interest in one or more content items (3, 61, 89, 100, 220-240, 350, 360, 461-483, 705-750, 1700, 1703-1775, 1865).

31. The method (800) of item 30, wherein the default set of recommendations is based on a prediction of interest in at least one of a title (710, 725, 740, 755, 905), a genre (910), a release date (915), a release decade (920), an MPAA rating (925), a critical rating (930), a season number (935), an episode number (940), a director (945), an actor (950), a character (955), a depicted object (960), a depicted setting (965), an actual setting (970), a type of action (975), a type of interaction (980), a plot origin point (985), or a plot end point (990).

32. The method (800) of item 1, further comprising generating for display a user interface (17, 37, 67, 97, 300, 400, 600), wherein the user interface (17, 37, 67, 97, 300, 400, 600) is configured to display one or more graphical representations of a ratio of the one or more content items (3, 61, 89, 100, 220-240, 350, 360, 461-483, 705-750, 1700, 1703-1775, 1865) that include the one or more attributes (110-150, 760-790b, 900, 905-995) versus a total number of the one or more content items (3, 61, 89, 100, 220-240, 350, 360, 461-483, 705-750, 1700, 1703-1775, 1865) displayed in the user interface (17, 37, 67, 97, 300, 400, 600), and wherein the one or more attributes (110-150, 760-790b, 900, 905-995) include at least one of a title (710, 725, 740, 755, 905), a genre (910), a release date (915), a release decade (920), an MPAA rating (925), a critical rating (930), a season number (935), an episode number (940), a director (945), an actor (950), a character (955), a depicted object (960), a depicted setting (965), an actual setting (970), a type of action (975), a type of interaction (980), a plot origin point (985), or a plot end point (990).

33. The method (800) of item 1, wherein an interest in one or more attributes (110-150, 760-790b, 900, 905-995) is determined based on a presentation of one or more content trailers associated with the one or more content items (3, 61, 89, 100, 220-240, 350, 360, 461-483, 705-750, 1700, 1703-1775, 1865).

34. The method (800) of item 33, wherein the one or more content trailers are presented during a sign-up phase.

35. The method (800) of item 33, wherein an interest in one or more attributes (110-150, 760-790b, 900, 905-995) is determined based on a rating (925, 930) of the one or more content trailers associated with the one or more content items (3, 61, 89, 100, 220-240, 350, 360, 461-483, 705-750, 1700, 1703-1775, 1865).

36. The method (800) of item 1, further comprising generating the knowledge graph (700, including a knowledge graph based on attributes 900) based on feedback given about one or more content trailers.

37. The method (800) of item 1, wherein the content recommendation is based at least in part on the knowledge graph (700, including a knowledge graph based on attributes 900) for a plurality of subscribers.

38. The method (800) of item 1, wherein the content recommendation is based on at least one of determining one or more content items (3, 61, 89, 100, 220-240, 350, 360, 461-483, 705-750, 1700, 1703-1775, 1865) with similar attributes (110) when compared to a content item (3, 61, 89, 100, 220-240, 350, 360, 461-483, 705-750, 1700, 1703-1775, 1865) receiving a favorable reaction associated with a user device (3, 1902), determining that a user device played or is playing an entirety or a substantial portion of a content item (3, 61, 89, 100, 220-240, 350, 360, 461-483, 705-750, 1700, 1703-1775, 1865) or a series of content items (3, 61, 89, 100, 220-240, 350, 360, 461-483, 705-750, 1700, 1703-1775, 1865) related to each other, determining that a user device has re-watched one or more content items (3, 61, 89, 100, 220-240, 350, 360, 461-483, 705-750, 1700, 1703-1775, 1865), or determining that a user device has binge-watched a series of content items (3, 61, 89, 100, 220-240, 350, 360, 461-483, 705-750, 1700, 1703-1775, 1865).

39. The method (800) of item 1, wherein the content recommendation is based on one or more knowledge graphs of one or more content items.

40. The method (800) of item 39, wherein the one or more knowledge graphs are represented or modeled with objects as vertices, with each object having a unique identifier, with each object having a key-value pair, and with each object connected to other objects via edges describing a relationship between the objects.

41. The method (800) of item 40, wherein each object is a content item (3, 61, 89, 100, 220-240, 350, 360, 461-483, 705-750, 1700, 1703-1775, 1865) including at least one of a title (710, 725, 740, 755, 905), a genre (910), a release date (915), a release decade (920), an MPAA rating (925), a critical rating (930), a season number (935), an episode number (940), a director (945), an actor (950), a character (955), a depicted object (960), a depicted setting (965), an actual setting (970), a type of action (975), a type of interaction (980), a plot origin point (985), or a plot end point (990).

42. The method (800) of item 40, wherein the relationship between the objects includes at least one of a prequel-sequel pairing, a series relationship, a season relationship, an episodic relationship, or a related content relationship.

43. The method (800) of item 40, wherein the relationship between objects includes at least one source node and at least one target node.

44. The method (800) of item 43, wherein each pair of the at least one source node and the at least one target node has one or more edges therebetween.

45. The method (800) of item 44, wherein each edge has one or more properties.

46. The method (800) of item 1, wherein the knowledge graph (700, including a knowledge graph based on attributes 900) is based on at least one of an analysis of closed caption data, a video analysis using machine vision, or a deep neural network model.

47. The method (800) of item 46, wherein the closed caption data includes an analysis of sentences.

48. The method (800) of item 46, wherein analysis of at least one of the closed caption data, the machine vision, or the deep neural network model extracts one or more features from one or more video frames.

49. The method (800) of item 46, wherein analysis of at least one of the closed caption data, the machine vision, or the deep neural network model creates tags and/or vectors for one or more frames for the one or more content items (3, 61, 89, 100, 220-240, 350, 360, 461-483, 705-750, 1700, 1703-1775, 1865).

50. The method (800) of item 46, wherein the closed caption data includes a textual representation of at least one of audio, a non-speech element, a character identification, a sound effect, a language identification, an expressed emotion, a music lyric, or timing metadata (1840).

51. The method (800) of item 1, the method (800) further comprising updating an existing knowledge graph to include output from the analysis of at least one of the closed caption data, the machine vision, or the deep neural network model to create tags and/or vectors for one or more frames for the one or more content items (3, 61, 89, 100, 220-240, 350, 360, 461-483, 705-750, 1700, 1703-1775, 1865).

52. The method (800) of item 1, the method (800) further comprising weighting one or more events in the one or more content items (3, 61, 89, 100, 220-240, 350, 360, 461-483, 705-750, 1700, 1703-1775, 1865) with one or more attributes (110-150, 760-790b, 900, 905-995) determined by the analysis of at least one of the closed caption data, the machine vision, or the deep neural network model.

53. The method (800) of item 52, wherein the weighting is determined based on a video phase and/or an analysis phase of a computer vision system.

54. The method (800) of item 1, the method (800) further comprising determining a relationship strength between two or more content items (3, 61, 89, 100, 220-240, 350, 360, 461-483, 705-750, 1700, 1703-1775, 1865).

55. The method (800) of item 54, wherein the relationship strength is based on one or more labels determined from the analysis of at least one of the closed caption data, the machine vision, or the deep neural network model.

56. The method (800) of item 54, wherein the relationship strength is based on an extent of an overlap between the one or more labels determined from the analysis of at least one of the closed caption data, the machine vision, or the deep neural network model.

57. The method (800) of item 54, wherein the relationship strength is based on an analysis of a timing of events within the one or more content items (3, 61, 89, 100, 220-240, 350, 360, 461-483, 705-750, 1700, 1703-1775, 1865).

58. The method (800) of item 1, wherein a search (1605) for content (3, 1715, 1721, 1724, 1727, 1730, 1733, 1736, 1739, 1754, 1760, 1769, 1772, 1775) is based on a search (1605) of the knowledge graph (700, including a knowledge graph based on attributes 900).

59. The method (800) of item 1, wherein one or more trailers are presented based on the search (1605) of the knowledge graph (700, including a knowledge graph based on attributes 900).

60. The method (800) of item 1, wherein one or more trailers are presented based on metadata (1840) including demographics of an audience associated with certain content.

61. The method (800) of item 1, wherein one or more trailers are presented in a sign-up phase based on trailers of new releases relatively highly favored by a particular gender classification within a particular age range.

62. The method (800) of item 1, wherein a list of one or more additional trailers is determined based on ratings of presented trailers.

63. The method (800) of item 1, wherein customized metadata is generated for each user device and for each of the one or more content items (3, 61, 89, 100, 220-240, 350, 360, 461-483, 705-750, 1700, 1703-1775, 1865).

64. The method (800) of item 63, wherein the customized metadata replaces generic metadata (1840) provided for a given content item.

65. The method (800) of item 1, the method (800) further comprising analysis based on at least one of collaborative filtering; content-based recommendations; context-aware recommendation systems; prediction of quality and/or popularity of a content item (3, 61, 89, 100, 220-240, 350, 360, 461-483, 705-750, 1700, 1703-1775, 1865) from metadata (1840); or a feature extractor.

66. The method (800) of item 1, wherein the content recommendation is based on at least one of a determination of preferences of a group of users determined to have similarity with a given user, the viewing history, the user preference, a genre (910), a sub-genre (910), an actor (950), a cast, a time of day, a device type, a location, a language, the knowledge graph (700, including a knowledge graph based on attributes 900), natural language processing, a plot summary, tokenization, stemming, TF-IDF, K-means, similarity distance, deep learning-based classification models, ML analysis, or knowledge acquisition.

67. A system (1900) comprising control circuitry (1902, 1908, 1934) configured to perform one or more functions of items 1-66.

68. A non-transitory, computer-readable medium having non-transitory, computer-readable instructions encoded thereon that, when executed by control circuitry (1902, 1908, 1934), cause the control circuitry (1902, 1908, 1934) to perform one or more functions of items 1-66.

69. A device (2, 11, 1902, 1904) comprising one or more means to perform one or more functions of items 1-66.

### Definitions

The terminology used herein is for the purpose of describing embodiments only and is not intended to be limiting of the disclosure. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes all combinations of one or more of the associated listed items.

Although at least one exemplary embodiment is described as using a plurality of units to perform the exemplary process, it is understood that the exemplary processes may also be performed by one or a plurality of modules. Additionally, it is understood that the term controller/control unit may refer to a hardware device that includes a memory and a processor. The memory may be configured to store the modules, and the processor may be specifically configured to execute said modules to perform one or more processes, which are described further below.

The use of the terms “first,” “second,” “third,” and so on, herein, are provided to identify structures or operations, without describing an order of structures or operations, and, to the extent the structures or operations are used in an exemplary embodiment, the structures may be provided, or the operations may be executed in a different order from the stated order unless a specific order is definitely specified in the context.

The use of the phrases such as, for example, “at least one of A, B, or C” should be understood to mean “only A, only B, only C, both A and B, both A and C, both B and C, or all of A, B, and C.”

The methods and/or any instructions for performing any of the embodiments discussed herein may be encoded on computer-readable media. Computer-readable media includes any media capable of storing data. The computer-readable media may be transitory, including, but not limited to, propagating electrical or electromagnetic signals, or may be non-transitory (e.g., a non-transitory, computer-readable medium accessible by an application via control or processing circuitry from storage) including, but not limited to, volatile and non-volatile computer memory or storage devices such as a hard disk, floppy disk, USB drive, DVD, CD, media cards, register memory, processor caches, random access memory (RAM), etc.

The interfaces, processes, and analysis described may be performed by an application. The application may be loaded directly onto each device of any of the systems described or may be stored in a remote server or any memory and processing circuitry accessible to each device in the system. The generation of interfaces and analysis there-behind may be performed at a receiving device, a sending device, or some device or processor therebetween.

The systems and processes discussed herein are intended to be illustrative and not limiting. One skilled in the art would appreciate that the actions of the processes discussed herein may be omitted, modified, combined, and/or rearranged, and any additional actions may be performed. More generally, the disclosure herein is meant to be exemplary and not limiting. Only the claims that follow are meant to set bounds as to what the present disclosure includes. Furthermore, it should be noted that the features and limitations described in any one exemplary embodiment may be applied to any other exemplary embodiment herein, and flowcharts or examples relating to one exemplary embodiment may be combined with any other exemplary embodiment in a suitable manner, done in different orders, or done in parallel. In addition, the methods and systems described herein may be performed in real time. It should also be noted that the systems and/or methods described herein may be applied to, or used in accordance with, other systems and/or methods.

Accordingly, this description is to be taken only by way of example and not to otherwise limit the scope of the embodiments herein. Therefore, it is the object of the appended claims to cover all such variations and modifications as come within the true spirit and scope of the embodiments herein.

1. A method for providing content recommendations from among a plurality of content items, the method comprising:
accessing a knowledge graph of a content item, the knowledge graph based on at least one of an attribute of the content item, metadata regarding the content item, a viewing history, a user preference determined by analysis, or a user preference selected by a user;
selecting one or more attributes of interest from a plurality of attributes of the content item;
generating a content recommendation based on the selected one or more attributes of interest; and
generating for display a user interface, wherein the user interface changes in response to selections of one or more values and/or weights of the one or more attributes of interest.

2. The method of claim 1, wherein the user preference determined by analysis is determined based on an analysis of at least one of the attributes of the content item, the metadata of the content item, the viewing history, or the user preference selected by the user.

3. The method of claim 1, wherein the content recommendation only includes portions of one or more original content items that include the selected one or more attributes of interest.

4. The method of claim 1, wherein the content recommendation only includes one or more content items that include the selected one or more attributes of interest.

5. The method of claim 1, further comprising determining a prediction of likely interest in one or more content items based on the analysis of the one or more of the attributes of the content item, the metadata of the content item, and the user preference selected by the user.

6. The method of claim 1, wherein the attribute is at least one of a title, a genre, a release date, a release decade, an MPAA rating, a critical rating, a season number, an episode number, a director, an actor, a character, a depicted object, a depicted setting, an actual setting, a type of action, a type of interaction, a plot origin point, or a plot end point.

7. The method of claim 1, further comprising generating for display a user interface with one or more options to search one or more content items based on the selected one or more attributes of interest.

8. (canceled)

9. The method of claim 1, further comprising generating for display a user interface,
wherein the user interface is configured to display a timeline referencing the one or more content items,
wherein the timeline is a series of occurrences in the one or more content items that form a plot or part of a plot of the one or more content items,
wherein the attribute includes the timeline or a combination of one or more attributes and the timeline, and
wherein the one or more attributes are mapped along the timeline.

10.-18. (canceled)

19. A method comprising:
accessing a knowledge graph of a content item, the knowledge graph based on each of an attribute of the content item, metadata regarding the content item, a viewing history, a user preference determined by analysis, and a user preference selected by a user;
selecting one or more attributes of interest from a plurality of attributes of the content item;
generating a content recommendation based on the selected one or more attributes of interest; and
generating for display a user interface, wherein the user interface is configured to display one or more graphical representations of a number of the one or more content items that include the one or more attributes, and the content recommendation and wherein the user interface changes in response to selections of one or more values and/or weights of the one or more attributes of interest.

20.-69. (canceled)

70. A system for providing content recommendations from among a plurality of content items, the system comprising:
circuitry configured to:
access a knowledge graph of a content item, the knowledge graph based on at least one of an attribute of the content item, metadata regarding the content item, a viewing history, a user preference determined by analysis, or a user preference selected by a user;
select one or more attributes of interest from a plurality of attributes of the content item;
generate a content recommendation based on the selected one or more attributes of interest; and
generate for display a user interface, wherein the user interface changes in response to selections of one or more values and/or weights of the one or more attributes of interest.

71. The system of claim 70, wherein the user preference determined by analysis is determined based on an analysis of at least one of the attributes of the content item, the metadata of the content item, the viewing history, or the user preference selected by the user.

72. The system of claim 70, wherein the content recommendation only includes portions of one or more New content items that include the selected one or more attributes of interest.

73. The system of claim 70, wherein the content recommendation only includes one or more content items that include the selected one or more attributes of interest.

74. The system of claim 70, wherein the circuitry is configured to determine a prediction of likely interest in one or more content items based on the analysis of the one or more of the attributes of the content item, the metadata of the content item, and the user preference selected by the user.

75. The system of claim 70, wherein the attribute is at least one of a title, a genre, a release date, a release decade, an MPAA rating, a critical rating, a season number, an episode number, a director, an actor, a character, a depicted object, a depicted setting, an actual setting, a type of action, a type of interaction, a plot origin point, or a plot end point.

76. The system of claim 70, wherein the circuitry is configured to generate for display a user interface with one or more options to search one or more content items based on the selected one or more attributes of interest.

77. (canceled)

78. The system of claim 70, wherein the circuitry is configured to generate for display a user interface,
wherein the user interface is configured to display a timeline referencing the one or more content items,
wherein the timeline is a series of occurrences in the one or more content items that form a plot or part of a plot of the one or more content items,
wherein the attribute includes the timeline or a combination of one or more attributes and the timeline, and
wherein the one or more attributes are mapped along the timeline.

79. The system of claim 70, wherein the circuitry is configured to generate for display a user interface, wherein the user interface is configured to display one or more graphical representations of a number of the one or more content items that include the one or more attributes.
